(19) United States
(12) Patent Application Publication
(10) Pub. No.: US 2026/0260607 A1
(43) Pub. Date: Sep. 3, 2026

(54) PIXEL CIRCUIT, PIXEL DRIVING CIRCUIT AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN); Beijing BOE Technology Development Co., Ltd., Beijing (CN)

(72) Inventors: Yao HUANG, Beijing (CN); Haijun QIU, Beijing (CN); Ming HU, Beijing (CN); Xiangdan DONG, Beijing (CN); Dongfang YANG, Beijing (CN); Yongliang ZHAO, Beijing (CN); Mengmeng DU, Beijing (CN)

(21) Appl. No.: 18/834,492

(22) PCT Filed: Oct. 30, 2023
(86) PCT No.: PCT/CN2023/127875

§ 371 Date: Jul. 30, 2024

(51) Int. Cl. G09G 3/3233

(52) U.S. Cl. CPC G09G 3/3233; G09G 2300/0819; G09G 2300/0852; G09G 2300/0861; G09G 2310/08; G09G 2320/0223; G09G 2320/0233

(57) ABSTRACT

A pixel circuit includes a driving circuit, a first light emitting control circuit and a light emitting element; a first terminal of the driving circuit is electrically connected to a second node, a second terminal of the driving circuit is electrically connected to a first voltage line, and the driving circuit is configured to control to generate a driving current under the control of a potential of the first node; the first light emitting control circuit is configured to control to connect or disconnect the first electrode of the light emitting element and the second voltage line under the control of the first light emitting control signal; or, the first light emitting control circuit is configured to control to connect or disconnect the second electrode of the light emitting element and the second node under the control of the first light emitting control signal.

### TECHNICAL FIELD

The present disclosure relates to the field of display technology, in particular to a pixel circuit, a pixel driving circuit and a display device.

### BACKGROUND

In the related art, the low voltage line is routed through the cathode layer. Due to the large cathode resistance, the IR voltage drop of the low voltage line is large. When the pixel circuit is working, the source voltage of the driving transistor is unstable, causing the display brightness to change.

### SUMMARY

In one aspect, the present disclosure provides in some embodiments a pixel circuit, including a driving circuit, a first light emitting control circuit and a light emitting element; wherein a control terminal of the driving circuit is electrically connected to a first node, a first terminal of the driving circuit is electrically connected to a second node, a second terminal of the driving circuit is electrically connected to a first voltage line, and the driving circuit is configured to control to generate a driving current under the control of a potential of the first node; a first electrode of the light emitting element is electrically connected to a second voltage line through the first light emitting control circuit, and a second electrode of the light emitting element is electrically connected to the second node, the first light emitting control circuit is configured to control to connect or disconnect the first electrode of the light emitting element and the second voltage line under the control of a first light emitting control signal provided by the first light emitting control terminal; or, the first electrode of the light emitting element is electrically connected to the second voltage line, and the second electrode of the light emitting element is electrically connected to the second node through the first light emitting control circuit, the first light emitting control circuit is configured to control to connect or disconnect the second electrode of the light emitting element and the second node under the control of the first light emitting control signal.

Optionally, the pixel circuit further includes a second light emitting control circuit; wherein the second terminal of the driving circuit is electrically connected to the first voltage line through the second light emitting control circuit; the second light emitting control circuit is electrically connected to the second light emitting control terminal, and is configured to control to connect or disconnect the second terminal of the driving circuit and the first voltage line under the control of a second light emitting control signal provided by the second light emitting control terminal.

Optionally, the pixel circuit further includes a first energy storage circuit, a second energy storage circuit, a data writing-in circuit, an on-off control circuit and a first initialization circuit; wherein the second terminal of the driving circuit is directly electrically connected to a third node; a first terminal of the first energy storage circuit is electrically connected to the third node, a second terminal of the first energy storage circuit is electrically connected to a fourth node, a first terminal of the second energy storage circuit is electrically connected to the fourth node, a second terminal of the second energy storage circuit is electrically connected to a fifth node, and the first energy storage circuit and the second energy storage circuit are configured to store electric energy; the data writing-in circuit is electrically connected to a scanning terminal, a data line and the fifth node respectively, and is configured to write a data voltage provided by the data line into the fifth node under the control of a scanning signal provided by the scanning terminal; the on-off control circuit is electrically connected to the second light emitting control terminal, the first node and the fifth node respectively, and is configured to control to connect or disconnect the first node and the fifth node under the control of the second light emitting control signal; the first initialization circuit is electrically connected to a first reset control terminal, a first initial voltage terminal and the first node respectively, and is configured to write a first initial voltage provided by the first initial voltage terminal into the first node under the control of a first reset control signal provided by the first reset control terminal.

Optionally, the pixel circuit further includes a second initialization circuit; wherein the second initialization circuit is electrically connected to the first reset control terminal, the first initial voltage terminal and the fourth node respectively, and is configured to write the first initial voltage into the fourth node under the control of the first reset control signal; or, the second initialization circuit is electrically connected to the first reset control terminal, the first node and the fourth node respectively, and is configured to control to connect or disconnect the first node and the fourth node under the control of the first reset control signal.

Optionally, the pixel circuit further includes a third initialization circuit; wherein the third initialization circuit is electrically connected to a second reset control terminal, a second initial voltage terminal and the second node, respectively, and is configured to write a second initial voltage provided by the second initial voltage terminal into the second node under the control of a second reset control signal provided by the second reset control terminal.

Optionally, the pixel circuit further includes a third energy storage circuit; wherein a first terminal of the third energy storage circuit is electrically connected to the first voltage line, a second terminal of the third energy storage circuit is electrically connected to the second voltage line, and the third energy storage circuit is configured to store electrical energy.

Optionally, the third energy storage circuit includes a third capacitor, the first energy storage circuit includes a first capacitor, and the second energy storage circuit includes a second capacitor; a first terminal of the first capacitor is electrically connected to the third node, and a second terminal of the first capacitor is electrically connected to the fourth node; a first terminal of the second capacitor is electrically connected to the fourth node, and a second terminal of the second capacitor is electrically connected to the fifth node; a first terminal of the third capacitor is electrically connected to the first voltage line, and a second terminal of the third capacitor is electrically connected to the second voltage line; a capacitance value of the third capacitor is less than a capacitance value of the first capacitor, and the capacitance value of the third capacitor is less than a capacitance value of the second capacitor.

Optionally, an absolute value of a difference between a voltage value of the second voltage signal provided by the second voltage line and a voltage value of the second initial voltage is smaller than an turn-on voltage of the light emitting element.

Optionally, a display period of the pixel circuit includes a reset phase and a light emitting phase that are successively arranged; the reset phase includes a set time period; the first light emitting control circuit is configured to control to connect the first electrode of the light emitting element and the second voltage line, or to connect the second electrode of the light emitting element and the second node, under the control of the first light emitting control signal, during the light emitting phase; the driving circuit is configured to control to generate a driving current to driving the light emitting element to emit light during the light emitting phase; the third initialization circuit is configured to write the second initial voltage into the second node under the control of the second reset control signal during the reset phase; the first light emitting control circuit is configured to control to connect the first electrode of the light emitting element and the second voltage line, or to connect the second electrode of the light emitting element and the second node, under the control of the first light emitting control signal, during the set time period.

Optionally, the display period further includes an initialization phase arranged before the reset phase, and a writing-in phase and a compensation phase arranged between the reset phase and the light emitting phase, the writing-in phase and the compensation phase are arranged successively; the first initialization circuit is configured to write the first initial voltage into the first node under the control of the first reset control signal in the initialization phase, the reset phase, the writing-in phase and the compensation phase; the on-off control circuit is configured to control to connect the first node and the fifth node under the control of the second light emitting control signal in the initialization phase, the reset phase, the writing-in phase and the light emitting phase; the data writing-in circuit is configured to write the data voltage provided by the data line to the fifth node under the control of the scanning signal in the writing-in phase; the third initialization circuit is configured to write the second initial voltage into the second node under the control of the second reset control signal in the compensation phase.

Optionally, the pixel circuit further includes a second initialization circuit; wherein the second initialization circuit is configured to write the first initial voltage into the fourth node under the control of the first reset control signal in the initialization phase, the reset phase, the writing-in phase and the compensation phase.

Optionally, the driving circuit includes a driving transistor, and the first light emitting control circuit includes a first light emitting control transistor; a gate electrode of the driving transistor is electrically connected to the first node, a first electrode of the driving transistor is electrically connected to the second node, and a second electrode of the driving transistor is electrically connected to the first voltage line; a gate electrode of the first light emitting control transistor is electrically connected to the first light emitting control terminal, a first electrode of the first light emitting control transistor is electrically connected to the first electrode of the light emitting element, and a second electrode of the first light emitting control transistor is electrically connected to the second voltage line; or, the gate electrode of the first light emitting control transistor is electrically connected to the first light emitting control terminal, the first electrode of the first light emitting control transistor is electrically connected to the second electrode of the light emitting element, and the second electrode of the first light emitting control transistor is electrically connected to the second node; the first energy storage circuit includes a first capacitor, the second energy storage circuit includes a second capacitor, the data writing-in transistor includes a writing-in transistor, the on-off control circuit includes an on-off control transistor, the first initialization circuit includes a first initialization transistor; a first terminal of the first capacitor is electrically connected to the third node, and a second terminal of the first capacitor is electrically connected to the fourth node; a first terminal of the second capacitor is electrically connected to the fourth node, and a second terminal of the second capacitor is electrically connected to the fifth node; a gate electrode of the writing-in transistor is electrically connected to the scanning terminal, a first electrode of the writing-in transistor is electrically connected to the data line, and a second electrode of the writing-in transistor is electrically connected to the fifth node; a gate electrode of the on-off control transistor is electrically connected to the second light emitting control terminal, a first electrode of the on-off control transistor is electrically connected to the first node, and a second electrode of the on-off control transistor is electrically connected to the fifth node; a gate electrode of the first initialization transistor is electrically connected to the first reset control terminal, a first electrode of the first initialization transistor is electrically connected to the first initial voltage terminal, and a second electrode of the first initialization transistor is electrically connected to the first node.

Optionally, the pixel circuit further includes a first energy storage circuit, a data writing-in circuit and a first initialization circuit; the second terminal of the driving circuit is directly electrically connected to the third node; a first terminal of the first energy storage circuit is electrically connected to the first node, and a second terminal of the first energy storage circuit is electrically connected to the third node, and the first energy storage circuit is configured to store electric energy; the data writing-in circuit is electrically connected to the scanning terminal, the data line and the first node respectively, and is configured to write the data voltage provided by the data line into the first node under the control of the scanning signal provided by the scanning terminal; the first initialization circuit is electrically connected to the first reset control terminal, the first initial voltage terminal and the first node respectively, and is configured to write the first initial voltage provided by the first initial voltage terminal into the first node under the control of the first reset control signal provided by the first reset control terminal.

Optionally, the pixel circuit further includes a third initialization circuit; wherein the third initialization circuit is electrically connected to the second reset control terminal, the second initial voltage terminal and the second node respectively, and is configured to write the second initial voltage provided by the second initial voltage terminal into the second node under the control of the second reset control signal provided by the second reset control terminal.

Optionally, the second electrode of the light emitting element is electrically connected to the second node through the first light emitting control circuit; the pixel circuit further includes a fourth initialization circuit; the fourth initialization circuit is electrically connected to the second reset control terminal, the second electrode of the light emitting element and the second initial voltage terminal respectively, and is configured to write the second initial voltage into the second electrode of the light emitting element under the control of the second reset control signal.

Optionally, the pixel circuit further includes a third energy storage circuit; a first terminal of the third energy storage circuit is electrically connected to a DC voltage line, a second terminal of the third energy storage circuit is electrically connected to the third node, and the third energy storage circuit is configured to store electric energy.

Optionally, the first energy storage circuit comprises a first capacitor, and the third energy storage circuit comprises a third capacitor; a first terminal of the first capacitor is electrically connected to the first node, and a second terminal of the first capacitor is electrically connected to the third node; a first terminal of the third capacitor is electrically connected to the DC voltage line, and a second terminal of the third capacitor is electrically connected to the third node; a capacitance value of the third capacitor is less than a capacitance value of the first capacitor.

Optionally, the first energy storage circuit includes a first capacitor, the data writing-in circuit includes a writing-in transistor, and the first initialization circuit includes a first initialization transistor; a first terminal of the first capacitor is electrically connected to the first node, and a second terminal of the first capacitor is electrically connected to the third node; a gate electrode of the writing-in transistor is electrically connected to the scanning terminal, a first electrode of the writing-in transistor is electrically connected to the data line, and a second electrode of the writing-in transistor is electrically connected to the first node; a gate electrode of the first initialization transistor is electrically connected to the first reset control terminal, a first electrode of the first initialization transistor is electrically connected to the first initial voltage terminal, and a second electrode of the first initialization transistor is electrically connected to the first node.

Optionally, an absolute value of a difference between a voltage value of the second voltage signal provided by the second voltage line and a voltage value of the second initial voltage is less than a turn-on voltage of the light emitting element.

Optionally, a display period of the pixel circuit includes a reset phase and a light emitting phase which are successively arranged; the reset phase includes a set time period; the third initialization circuit is configured to write the second initial voltage into the second node under the control of the second reset control signal in the reset phase; the first light emitting control circuit is configured to control to connect the first electrode of the light emitting element and the second voltage line, or to control to connect the second electrode of the light emitting element and the second node under the control of the first light emitting control signal in the set time period.

Optionally, the display period further includes an initialization phase arranged before the reset phase, and a writing-in phase and a compensation phase arranged between the reset phase and the light emitting phase, the writing-in phase and the compensation phase are arranged successively; the first initialization circuit is configured to write the first initial voltage into the first node under the control of the first reset control signal during the initialization phase, the reset phase, the writing-in phase and the compensation phase; the third initialization circuit is configured to write the second initial voltage into the second node under the control of the second reset control signal during the compensation phase; the data writing-in circuit is configured to write the data voltage provided by the data line into the first node under the control of the scanning signal during the writing-in phase; the first light emitting control circuit is configured to control to connect the first electrode of the light emitting element and the second voltage line, or to control to connect the second electrode of the light emitting element and the second node under the control of the first light emitting control signal during the light emitting phase.

In a second aspect, an embodiment of the present disclosure provides a pixel driving method, applied to the pixel circuit, wherein the pixel driving method includes: controlling, by the driving circuit, to generate the driving current under the control of the potential of the first node; controlling, by the first light emitting control circuit, to connect or disconnect the first electrode of the light emitting element and the second voltage line under the control of the first light emitting control signal; or, controlling, by the first light emitting control circuit, to connect or disconnect the second electrode of the light emitting element and the second node under the control of the first light emitting control signal.

In a third aspect, an embodiment of the present disclosure provides a display device, comprising a base substrate and the pixel circuit arranged on the base substrate.

Optionally, the display device further includes a first voltage line and a plurality of metal layers arranged on the base substrate; wherein a transistor in the pixel circuit is arranged on the metal layer; at least part of the first voltage line is formed on the metal layer.

Optionally, the display device further includes a first electrode layer, a light emitting material layer and a second electrode layer; wherein the first electrode layer, the light emitting material layer and the second electrode layer are arranged in sequence along a direction in which the metal layer is away from the base substrate; the first electrode of the light emitting element is formed in the second electrode layer, and the second electrode of the light emitting element is formed in the first electrode layer; a part of the first voltage line is formed in the first electrode layer.

### BRIEF DESCRIPTION OF THE DRAWINGS

FIG. 1 is a structural diagram of a pixel circuit according to an embodiment of the present disclosure;

FIG. 2 is a structural diagram of a pixel circuit according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7 is a structural diagram of a pixel circuit according to at least one embodiment of the present disclosure;

FIG. 8 is a structural diagram of a pixel circuit according to at least one embodiment of the present disclosure;

FIG. 9 is a structural diagram of a pixel circuit according to at least one embodiment of the present disclosure;

FIG. 10 is a structural diagram of a pixel circuit according to at least one embodiment of the present disclosure;

FIG. 11 is a structural diagram of a pixel circuit according to at least one embodiment of the present disclosure;

FIG. 12 is a structural diagram of a pixel circuit according to at least one embodiment of the present disclosure;

FIG. 13 is a structural diagram of a pixel circuit according to at least one embodiment of the present disclosure;

FIG. 14 is a structural diagram of a pixel circuit according to at least one embodiment of the present disclosure;

FIG. 15 is a structural diagram of a pixel circuit according to at least one embodiment of the present disclosure;

FIG. 16 is a structural diagram of a pixel circuit according to at least one embodiment of the present disclosure;

FIG. 17 is a circuit diagram of a pixel circuit according to at least one embodiment of the present disclosure;

FIG. 18 is a timing diagram of the pixel circuit shown in FIG. 17;

FIG. 19 is a circuit diagram of a pixel circuit according to at least one embodiment of the present disclosure;

FIG. 20 is a circuit diagram of a pixel circuit according to at least one embodiment of the present disclosure;

FIG. 21 is a circuit diagram of a pixel circuit according to at least one embodiment of the present disclosure;

FIG. 22 is a circuit diagram of a pixel circuit according to at least one embodiment of the present disclosure;

FIG. 23 is a circuit diagram of a pixel circuit according to at least one embodiment of the present disclosure;

FIG. 24 is a structural diagram of a pixel circuit according to at least one embodiment of the present disclosure;

FIG. 25 is a structural diagram of a pixel circuit according to at least one embodiment of the present disclosure;

FIG. 26 is a structural diagram of a pixel circuit according to at least one embodiment of the present disclosure;

FIG. 27 is a structural diagram of a pixel circuit according to at least one embodiment of the present disclosure FIG. 28 is a structural diagram of a pixel circuit described in at least one embodiment of the present disclosure;

FIG. 29 is a circuit diagram of a pixel circuit described in at least one embodiment of the present disclosure;

FIG. 30 is a timing diagram of the pixel circuit shown in FIG. 29;

FIG. 31 is a circuit diagram of a pixel circuit described in at least one embodiment of the present disclosure;

FIG. 32 is a circuit diagram of a pixel circuit described in at least one embodiment of the present disclosure;

FIG. 33 is a circuit diagram of a pixel circuit described in at least one embodiment of the present disclosure;

FIG. 34 is a circuit diagram of a pixel circuit described in at least one embodiment of the present disclosure;

FIG. 35 is a circuit diagram of a pixel circuit described in at least one embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without making creative efforts fall within the scope of protection of the present disclosure.

The transistors used in all embodiments of the present disclosure may be thin film transistors, field effect transistors, or other devices with the same characteristics. In the embodiment of the present disclosure, in order to distinguish the two electrodes of the transistor except the gate electrode, one electrode is called the first electrode and the other electrode is called the second electrode.

In actual operation, when the transistor is a thin film transistor or a field effect transistor, the first electrode may be a drain electrode, and the second electrode may be a source electrode; or, the first electrode may be a source electrode, the second electrode may be a drain electrode.

The pixel circuit described in the embodiment of the present disclosure includes a driving circuit, a first light emitting control circuit and a light emitting element;

A control terminal of the driving circuit is electrically connected to a first node, a first terminal of the driving circuit is electrically connected to a second node, a second terminal of the driving circuit is electrically connected to a first voltage line, and the driving circuit is configured to control to generate a driving current under the control of a potential of the first node;
a first electrode of the light emitting element is electrically connected to a second voltage line through the first light emitting control circuit, and a second electrode of the light emitting element is electrically connected to the second node. The first light emitting control circuit is configured to control to connect or disconnect the first electrode of the light emitting element and the second voltage line under the control of the first light emitting control signal provided by the first light emitting control terminal; or, the first electrode of the light emitting element is electrically connected to a second voltage line, and the second electrode of the light emitting element is electrically connected to the second node through the first light emitting control circuit. The first light emitting control circuit is configured to control to connect or disconnect the second electrode of the light emitting element and the second node under the control of the first light emitting control signal.

The embodiment of the present disclosure provides a pixel circuit, which stabilizes the uniformity of the brightness of the picture of the pixel circuit at high and low grayscales by stabilizing the source voltage of the driving transistor included in the driving circuit, and improves the phenomenon of uneven brightness caused by the fluctuation of the IR voltage drop of the first voltage line.

In the disclosed embodiment, the second electrode of the light emitting element is set to be electrically connected to the driving circuit, and the source voltage of the driving transistor is stabilized by inverting the light emitting element.

Optionally, the first voltage line can be a low voltage line, and the second voltage line can be a high voltage line.

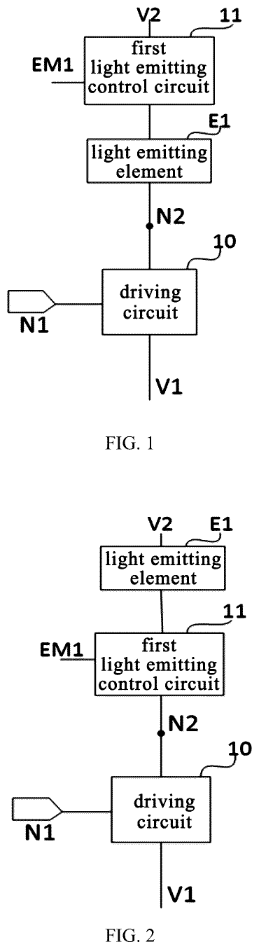

As shown in FIG. 1, the pixel circuit described in the embodiment of the present disclosure includes a driving circuit 10, a first light emitting control circuit 11 and a light emitting element E1;

The control terminal of the driving circuit 10 is electrically connected to the first node N1, the first terminal of the driving circuit 10 is electrically connected to the second node N2, the second terminal of the driving circuit 10 is electrically connected to the first voltage line V1, and the driving circuit 10 is configured to control to generate a driving current under the control of the potential of the first node N1;

The first electrode of the light emitting element E1 is electrically connected to the second voltage line V2 through the first light emitting control circuit 11, the second electrode of the light emitting element E1 is electrically connected to the second node N2, the first light emitting control circuit 11 is also electrically connected to the first light emitting control terminal EM1, and the first light emitting control circuit 11 is configured to control to connect or disconnect the first electrode of the light emitting element E1 and the second voltage line V2 under the control of the first light emitting control signal provided by the first light emitting control terminal EM1.

As shown in FIG. 2, the pixel circuit described in the embodiment of the present disclosure includes a driving circuit 10, a first light emitting control circuit 11 and a light emitting element E1;

The control terminal of the driving circuit 10 is electrically connected to the first node N1, the first terminal of the driving circuit 10 is electrically connected to the second node N2, the second terminal of the driving circuit 10 is electrically connected to the first voltage line V1, and the driving circuit 10 is configured to control to generate a driving current under the control of the potential of the first node N1;

The first electrode of the light emitting element E1 is electrically connected to the second voltage line V2, the second electrode of the light emitting element E1 is electrically connected to the second node N2 through the first light emitting control circuit 11, and the first light emitting control circuit 11 is also electrically connected to the first light emitting control terminal EM1, and the first light emitting control circuit 11 is configured to control to connect or disconnect the second electrode of the light emitting element E1 and the second node N2 under the control of the first light emitting control signal.

The pixel circuit described in at least one embodiment of the present disclosure further includes a second light emitting control circuit;

The second terminal of the driving circuit is electrically connected to the first voltage line through the second light emitting control circuit;

The second light emitting control circuit is electrically connected to the second light emitting control terminal, and is configured to control to connect or disconnect the second terminal of the driving circuit and the first voltage line under the control of the second light emitting control signal provided by the second light emitting control terminal.

In specific implementation, the pixel circuit may also include a second light emitting control circuit;

The second light emitting control circuit controls to connect or disconnect the second terminal of the driving circuit and the first voltage line under the control of the second light emitting control signal.

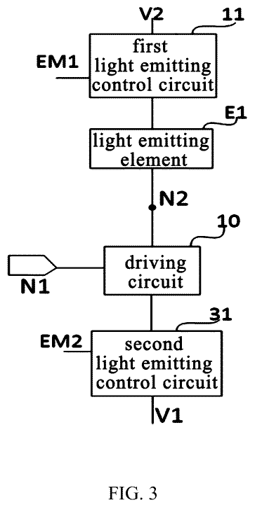

As shown in FIG. 3, based on at least one embodiment of the pixel circuit shown in FIG. 1, the pixel circuit described in at least one embodiment of the present disclosure further includes a second light emitting control circuit 31;

The second terminal of the driving circuit 10 is electrically connected to the first voltage line V1 through the second light emitting control circuit 31;

The second light emitting control circuit 31 is electrically connected to the second light emitting control terminal EM2, and is configured to control to connect or disconnect the second terminal of the driving circuit 10 and the first voltage line V1 under the control of the second light emitting control signal provided by the second light emitting control terminal EM2.

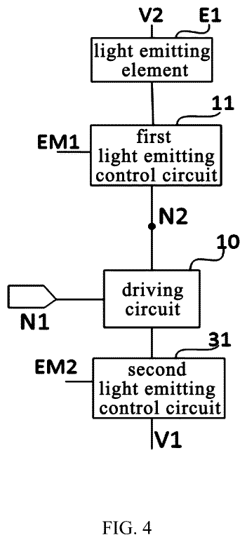

As shown in FIG. 4, based on at least one embodiment of the pixel circuit shown in FIG. 2, the pixel circuit described in at least one embodiment of the present disclosure further includes a second light emitting control circuit 31;

The second terminal of the driving circuit 10 is electrically connected to the first voltage line V1 through the second light emitting control circuit 31;

The second light emitting control circuit 31 is electrically connected to the second light emitting control terminal EM2, and is configured to control to connect or disconnect the second terminal of the driving circuit 10 and the first voltage line V1 under the control of the second light emitting control signal provided by the second light emitting control terminal EM2.

The pixel circuit described in at least one embodiment of the present disclosure further includes a first energy storage circuit, a second energy storage circuit, a data writing-in circuit, an on-off control circuit and a first initialization circuit;

The second terminal of the driving circuit is directly electrically connected to a third node;
a first terminal of the first energy storage circuit is electrically connected to the third node, a second terminal of the first energy storage circuit is electrically connected to a fourth node, a first terminal of the second energy storage circuit is electrically connected to the fourth node, a second terminal of the second energy storage circuit is electrically connected to a fifth node, and the first energy storage circuit and the second energy storage circuit are configured to store electric energy;

The data writing-in circuit is electrically connected to a scanning terminal, a data line and the fifth node respectively, and is configured to write a data voltage provided by the data line into the fifth node under the control of a scanning signal provided by the scanning terminal;

The on-off control circuit is electrically connected to the second light emitting control terminal, the first node and the fifth node respectively, and is configured to control to connect or disconnect the first node and the fifth node under the control of the second light emitting control signal;

The first initialization circuit is electrically connected to a first reset control terminal, a first initial voltage terminal and the first node respectively, and is configured to write a first initial voltage provided by the first initial voltage terminal into the first node under the control of a first reset control signal provided by the first reset control terminal.

In a specific implementation, the pixel circuit may further include a first energy storage circuit, a second energy storage circuit, a data writing-in circuit, an on-off control circuit and a first initialization circuit. The data writing-in circuit writes the data voltage into the fifth node under the control of the scanning signal; the on-off control circuit controls to connect or disconnect the first node and the fifth node under the control of the second light emitting control signal; the first initialization circuit writes the first initial voltage into the first node under the control of the first reset control signal to reset the potential of the first node.

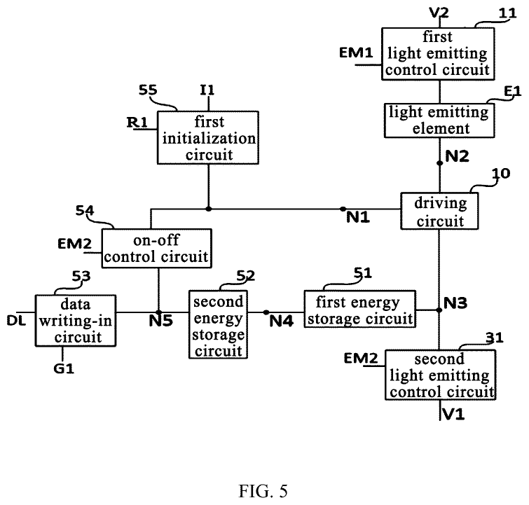

As shown in FIG. 5, based on at least one embodiment of the pixel circuit shown in FIG. 3, the pixel circuit described in at least one embodiment of the present disclosure further includes a first energy storage circuit 51, a second energy storage circuit 52, a data writing-in circuit 53, an on-off control circuit 54 and a first initialization circuit 55;

The second terminal of the driving circuit 10 is directly electrically connected to the third node N3;

The first terminal of the first energy storage circuit 51 is electrically connected to the third node N3, and the second terminal of the first energy storage circuit 51 is electrically connected to the fourth node N4;

The first terminal of the second energy storage circuit 52 is electrically connected to the fourth node N4, and the second terminal of the second energy storage circuit 52 is electrically connected to the fifth node N5;

The first energy storage circuit 51 and the second energy storage circuit 52 are configured to store electrical energy;

The data writing-in circuit 53 is respectively connected to the scanning terminal G1, the data line DL and the fifth node N5, and is configured to write the data voltage Vdata provided by the data line DL into the fifth node N5 under the control of the scanning signal provided by the scanning terminal G1;

The on-off control circuit 54 is electrically connected to the second light emitting control terminal EM2, the first node N1 and the fifth node N5 respectively, and is configured to control to connect or disconnect the first node N1 and the fifth node N5 under the control of the second light emitting control signal;

The first initialization circuit 55 is electrically connected to the first reset control terminal R1, the first initial voltage terminal I1 and the first node N1 respectively, and is configured to write the first initial voltage Vi1 provided by the first initial voltage terminal I1 into the first node N1 under the control of the first reset control signal provided by the first reset control terminal R1.

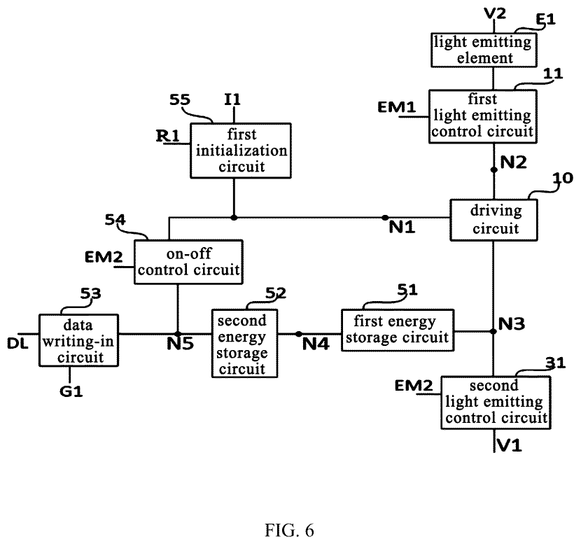

As shown in FIG. 6, based on at least one embodiment of the pixel circuit shown in FIG. 4, the pixel circuit described in at least one embodiment of the present disclosure further includes a first energy storage circuit 51, a second energy storage circuit 52, a data writing-in circuit 53, an on-off control circuit 54 and a first initialization circuit 55;

The second terminal of the driving circuit 10 is directly electrically connected to the third node N3;

The first terminal of the first energy storage circuit 51 is electrically connected to the third node N3, and the second terminal of the first energy storage circuit 51 is electrically connected to the fourth node N4;

The first terminal of the second energy storage circuit 52 is electrically connected to the fourth node N4, and the second terminal of the second energy storage circuit 52 is electrically connected to the fifth node N5;

The first energy storage circuit 51 and the second energy storage circuit 52 are configured to store electrical energy;

The data writing-in circuit 53 is respectively connected to the scanning terminal G1, the data writing-in circuit 53 and the fifth node N5, and is configured to write the data voltage Vdata provided by the data line DL into the fifth node N5 under the control of the scanning signal provided by the scanning terminal G1;

The on-off control circuit 54 is electrically connected to the second light emitting control terminal EM2, the first node N1 and the fifth node N5 respectively, and is configured to control to connect or disconnect the first node N1 and the fifth node N5 under the control of the second light emitting control signal;

The first initialization circuit 55 is electrically connected to the first reset control terminal R1, the first initial voltage terminal I1 and the first node N1 respectively, and is configured to write the first initial voltage Vi1 provided by the first initial voltage terminal I1 into the first node N1 under the control of the first reset control signal provided by the first reset control terminal R1.

In at least one embodiment of the present disclosure, the pixel circuit further includes a second initialization circuit;

The second initialization circuit is electrically connected to the first reset control terminal, the first initial voltage terminal and the fourth node respectively, and is configured to write the first initial voltage into the fourth node under the control of the first reset control signal; or,

The second initialization circuit is electrically connected to the first reset control terminal, the first node and the fourth node respectively, and is configured to control to connect or disconnect the first node and the fourth node under the control of the first reset control signal.

In specific implementation, the pixel circuit may also include a second initialization circuit, which writes the first initial voltage into the fourth node under the control of the first reset control signal, or controls to connect or disconnect the first node and the fourth node to reset the potential of the fourth node.

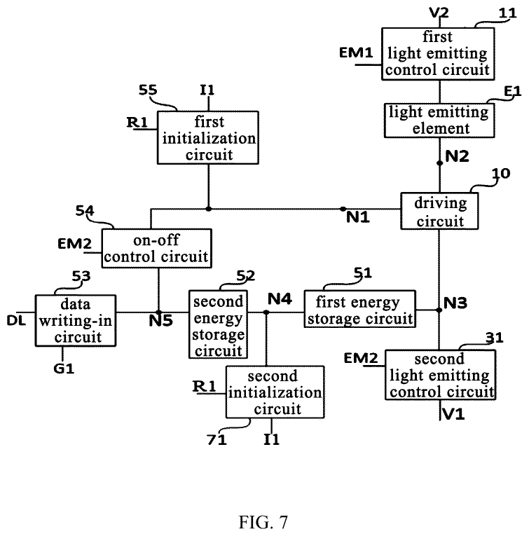

As shown in FIG. 7, based on at least one embodiment of the pixel circuit shown in FIG. 5, the pixel circuit described in at least one embodiment of the present disclosure further includes a second initialization circuit 71;

The second initialization circuit 71 is electrically connected to the first reset control terminal R1, the first initial voltage terminal I1 and the fourth node N4 respectively, and is configured to write the first initial voltage Vi1 into the fourth node N4 under the control of the first reset control signal.

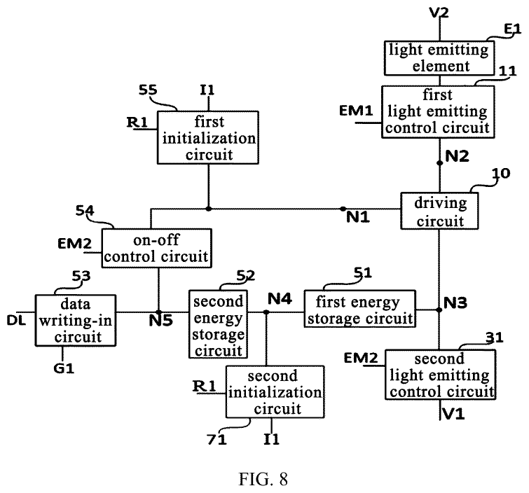

As shown in FIG. 8, based on at least one embodiment of the pixel circuit shown in FIG. 6, the pixel circuit described in at least one embodiment of the present disclosure further includes a second initialization circuit 71;

The second initialization circuit 71 is electrically connected to the first reset control terminal R1, the first initial voltage terminal I1 and the fourth node N4, respectively, and is configured to write the first initial voltage Vi1 into the fourth node N4 under the control of the first reset control signal.

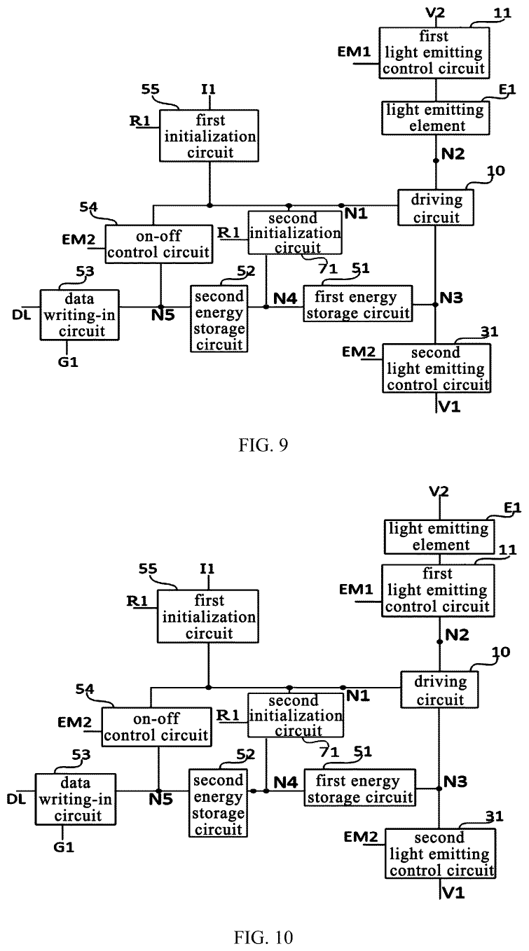

As shown in FIG. 9, based on at least one embodiment of the pixel circuit shown in FIG. 5, the pixel circuit described in at least one embodiment of the present disclosure further includes a second initialization circuit 71;

The second initialization circuit 71 is electrically connected to the first reset control terminal R1, the first node N1 and the fourth node N4, respectively, and is configured to control to connect or disconnect the first node N1 and the fourth node N4 under the control of the first reset control signal provided by the first reset control terminal R1.

As shown in FIG. 10, based on at least one embodiment of the pixel circuit shown in FIG. 6, the pixel circuit described in at least one embodiment of the present disclosure further includes a second initialization circuit 71;

The second initialization circuit 71 is electrically connected to the first reset control terminal R1, the first node N1 and the fourth node N4 respectively, and is configured to control to connect or disconnect the first node N1 and the fourth node N4 under the control of the first reset control signal provided by the first reset control terminal R1.

Optionally, the second node is electrically connected to the first node.

In a specific implementation, the second node can be electrically connected to the first node so that the potential of the second node can be reset while resetting the potential of the first node.

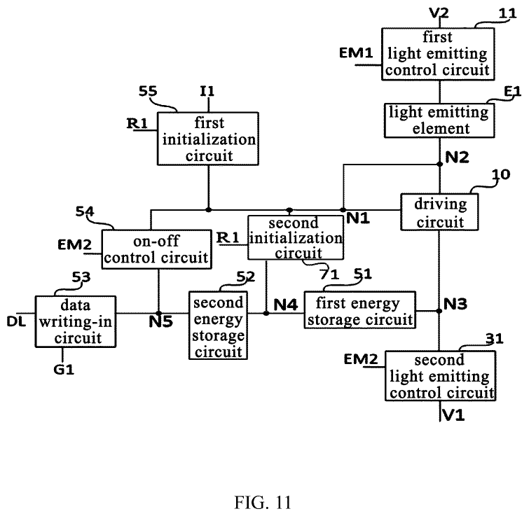

As shown in FIG. 11, based on at least one embodiment of the pixel circuit shown in FIG. 9, the second node N2 is electrically connected to the first node N1.

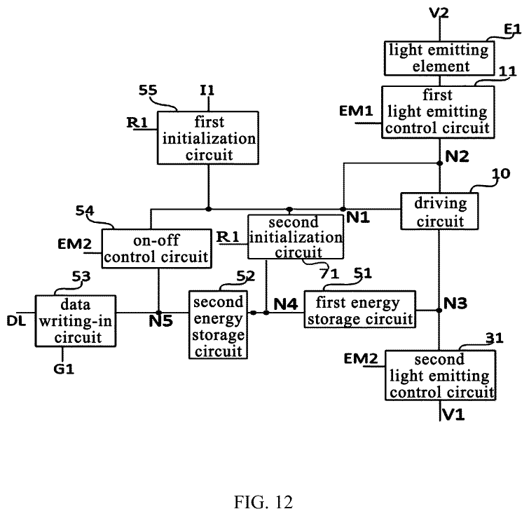

As shown in FIG. 12, based on at least one embodiment of the pixel circuit shown in FIG. 10, the second node N2 is electrically connected to the first node N1.

In at least one embodiment of the present disclosure, the pixel circuit further includes a third initialization circuit;

The third initialization circuit is electrically connected to the second reset control terminal, the second initial voltage terminal and the second node, respectively, and is configured to write the second initial voltage provided by the second initial voltage terminal into the second node under the control of the second reset control signal provided by the second reset control terminal.

In a specific implementation, the pixel circuit may further include a third initialization circuit, and the third initialization circuit writes the second initial voltage into the second node under the control of the second reset control signal to reset the potential of the second node.

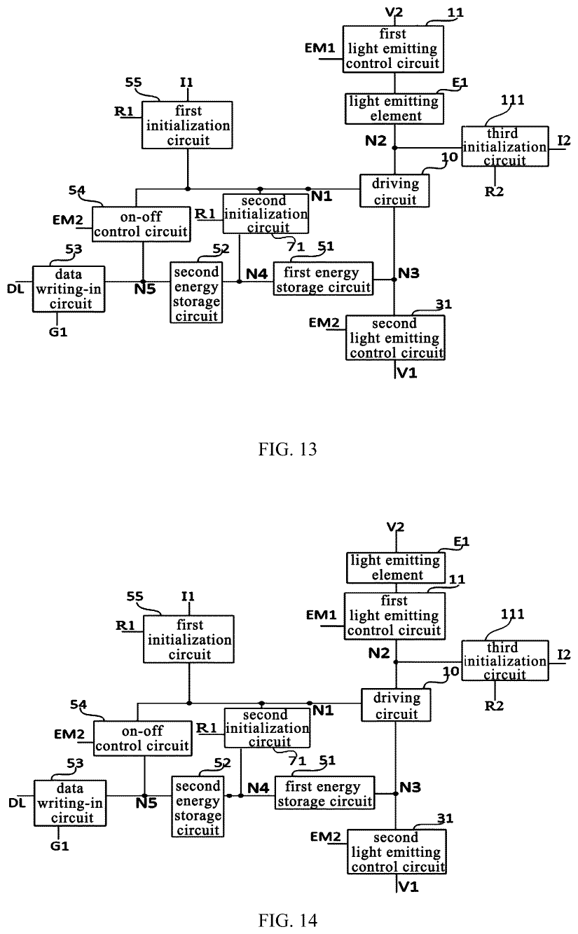

As shown in FIG. 13, based on at least one embodiment of the pixel circuit shown in FIG. 9, the pixel circuit described in at least one embodiment of the present disclosure further includes a third initialization circuit 111;

The third initialization circuit 111 is electrically connected to the second reset control terminal R2, the second initial voltage terminal 12 and the second node N2, respectively, and is configured to write the second initial voltage Vi2 provided by the second initial voltage terminal 12 into the second node N2 under the control of the second reset control signal provided by the second reset control terminal R2.

As shown in FIG. 14, based on at least one embodiment of the pixel circuit shown in FIG. 10, the pixel circuit described in at least one embodiment of the present disclosure further includes a third initialization circuit 111;

The third initialization circuit 111 is electrically connected to the second reset control terminal R2, the second initial voltage terminal 12 and the second node N2 respectively, and is configured to write the second initial voltage Vi2 provided by the second initial voltage terminal 12 into the second node N2 under the control of the second reset control signal provided by the second reset control terminal R2.

The pixel circuit described in at least one embodiment of the present disclosure further includes a third energy storage circuit;
a first terminal of the third energy storage circuit is electrically connected to the first voltage line, a second terminal of the third energy storage circuit is electrically connected to the second voltage line, and the third energy storage circuit is configured to store electric energy.

In specific implementation, the pixel circuit may further include a third energy storage circuit, the third energy storage circuit is electrically connected to the first voltage line and the second voltage line respectively, and the third energy storage circuit is configured to store electric energy; the third energy storage circuit can optimize the data voltage range of the pixel circuit to achieve better driving of low grayscale image quality.

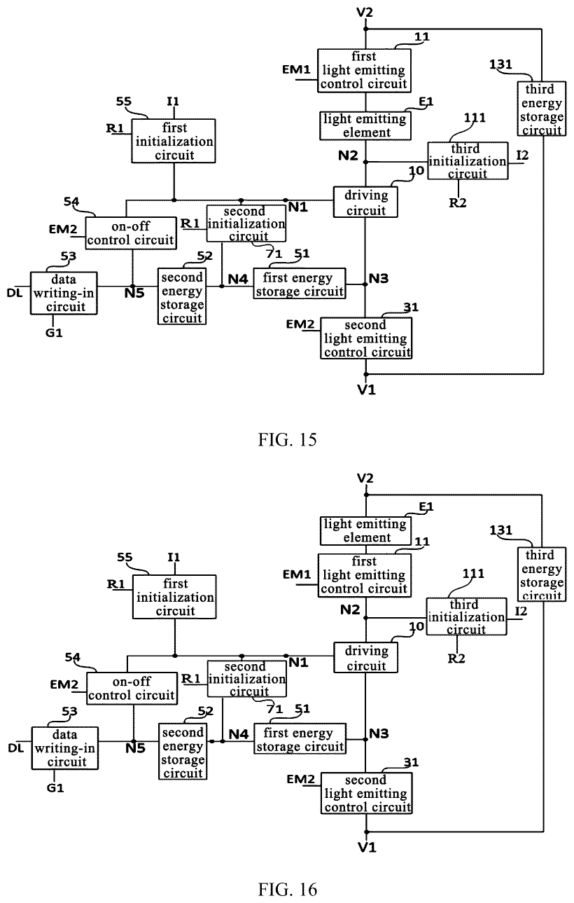

As shown in FIG. 15, based on at least one embodiment of the pixel circuit shown in FIG. 13, the pixel circuit described in at least one embodiment of the present disclosure further includes a third energy storage circuit 131;

The first terminal of the third energy storage circuit 131 is electrically connected to the first voltage line V1, the second terminal of the third energy storage circuit 131 is electrically connected to the second voltage line V2, and the third energy storage circuit 131 is configured to store electrical energy.

As shown in FIG. 16, based on at least one embodiment of the pixel circuit shown in FIG. 14, the pixel circuit described in at least one embodiment of the present disclosure further includes a third energy storage circuit 131;

The first terminal of the third energy storage circuit 131 is electrically connected to the first voltage line V1, the second terminal of the third energy storage circuit 131 is electrically connected to the second voltage line V2, and the third energy storage circuit 131 is configured to store electrical energy.

In at least one embodiment of the present disclosure, the absolute value of the difference between the voltage value of the second voltage signal provided by the second voltage line and the voltage value of the second initial voltage is less than the turn-on voltage of the light emitting element, so that the light emitting element does not emit light during a set time period.

Optionally, the third energy storage circuit includes a third capacitor, the first energy storage circuit includes a first capacitor, and the second energy storage circuit includes a second capacitor;
a first terminal of the first capacitor is electrically connected to the third node, and a second terminal of the first capacitor is electrically connected to the fourth node;
a first terminal of the second capacitor is electrically connected to the fourth node, and a second terminal of the second capacitor is electrically connected to the fifth node;
a first terminal of the third capacitor is electrically connected to the first voltage line, and a second terminal of the third capacitor is electrically connected to the DC voltage line;
a capacitance value of the third capacitor is less than a capacitance value of the first capacitor, and the capacitance value of the third capacitor is less than a capacitance value of the second capacitor.

In specific implementation, the first capacitor and the second capacitor are configured to store the threshold voltage of the driving transistor, and the third capacitor is configured to optimize the Data Range of the pixel circuit. Therefore, in the case where the space occupied by the pixel circuit is limited, the capacitance value of the first capacitor and the capacitance value of the second capacitor are preferentially guaranteed, so the capacitance value of the third capacitor can be set to be less than the capacitance value of the first capacitor, and the capacitance value of the third capacitor can be set to be less than the capacitance value of the second capacitor.

In at least one embodiment of the present disclosure, the display period of the pixel circuit includes a reset phase and a light emitting phase that are successively arranged; the reset phase includes a set time period;

The first light emitting control circuit is configured to control to connect the first electrode of the light emitting element and the second voltage line, or to connect the second electrode of the light emitting element and the second node, under the control of the first light emitting control signal, during the light emitting phase;

The driving circuit is configured to control to generate a driving current to driving the light emitting element to emit light during the light emitting phase;

The third initialization circuit is configured to write the second initial voltage into the second node under the control of the second reset control signal during the reset phase.

The first light emitting control circuit is configured to control to connect the first electrode of the light emitting element and the second voltage line, or to connect the second electrode of the light emitting element and the second node, under the control of the first light emitting control signal, during the set time period.

In a specific implementation, during the set time period, the third initialization circuit writes the second initial voltage into the second node under the control of the second reset control signal, and the first light emitting control circuit controls to connect the first electrode of the light emitting element and the second voltage line, or control to connect the second electrode of the light emitting element and the second node under the control of the first light emitting control signal, so as to reset the potential of the first electrode of the light emitting element and the potential of the second electrode of the light emitting element, clear the charge stored in the two electrodes of the light emitting element, and during the set time period, by setting the potential of the first electrode of the light emitting element and the potential of the second electrode of the light emitting element, control the light emitting element not to emit light.

In a specific implementation, the duration of the reset phase can be greater than the duration of the set time period, so that the light emitting element does not emit light during the reset phase.

In at least one embodiment of the present disclosure, the display period also includes an initialization phase arranged before the reset phase, and a writing-in phase and a compensation phase arranged between the reset phase and the light emitting phase, wherein the writing-in phase and the compensation phase are arranged successively;

The first initialization circuit is configured to write the first initial voltage into the first node under the control of the first reset control signal in the initialization phase, the reset phase, the writing-in phase and the compensation phase;

The on-off control circuit controls to connect the first node and the fifth node under the control of the second light emitting control signal in the initialization phase, the reset phase, the writing-in phase and the light emitting phase;

The data writing-in circuit is configured to write the data voltage provided by the data line to the fifth node under the control of the scanning signal in the writing-in phase;

The third initialization circuit is configured to write the second initial voltage into the second node under the control of the second reset control signal in the compensation phase.

In at least one embodiment of the present disclosure, the pixel circuit also includes a second initialization circuit;

The second initialization circuit is configured to write the first initial voltage into the fourth node under the control of the first reset control signal in the initialization phase, the reset phase, the writing-in phase and the compensation phase.

In specific implementation, the display period of the pixel circuit may include an initialization phase, a reset phase, a writing-in phase, a compensation phase and a light emitting phase that are successively set;

In the initialization phase, the first initialization circuit writes the first initial voltage into the first node under the control of the first reset control signal, and the on-off control circuit controls to connect the first node and the fifth node under the control of the second light emitting control signal, and the second initialization circuit writes the first initial voltage into the fourth node under the control of the first reset control signal;

In the reset phase, the first initialization circuit writes the first initial voltage into the first node under the control of the first reset control signal, and the on-off control circuit controls to connect the first node and the fifth node under the control of the second light emitting control signal, and the second initialization circuit writes the first initial voltage into the fourth node under the control of the first reset control signal, and the third initialization circuit writes the second initial voltage into the second node under the control of the second reset control signal;

In the writing-in phase, the first initialization circuit writes the first initial voltage into the first node under the control of the first reset control signal, and the on-off control circuit controls to connect the first node and the fifth node under the control of the second light emitting control signal, and the data writing-in circuit writes the data voltage provided by the data line into the fifth node under the control of the scanning signal; the second initialization circuit writes the first initial voltage into the fourth node under the control of the first reset control signal;

In the compensation phase, the first initialization circuit writes the first initial voltage into the first node under the control of the first reset control signal, and the second initialization circuit writes the first initial voltage into the fourth node under the control of the first reset control signal; the third initialization circuit writes the second initial voltage into the second node under the control of the second reset control signal;

In the light emitting phase, the first light emitting control circuit controls to connect the first electrode of the light emitting element and the second voltage line, or controls to connect the second electrode of the light emitting element and the second node under the control of the first light emitting control signal; the driving circuit controls to generates driving current to driving the light emitting element to emit light.

Optionally, the driving circuit includes a driving transistor, and the first light emitting control circuit includes a first light emitting control transistor;
a gate electrode of the driving transistor is electrically connected to the first node, a first electrode of the driving transistor is electrically connected to the second node, and a second electrode of the driving transistor is electrically connected to the first voltage line;
a gate electrode of the first light emitting control transistor is electrically connected to the first light emitting control terminal, a first electrode of the first light emitting control transistor is electrically connected to the first electrode of the light emitting element, and a second electrode of the first light emitting control transistor is electrically connected to the second voltage line; or, the gate electrode of the first light emitting control transistor is electrically connected to the first light emitting control terminal, the first electrode of the first light emitting control transistor is electrically connected to the second electrode of the light emitting element, and the second electrode of the first light emitting control transistor is electrically connected to the second node.

Optionally, the first energy storage circuit includes a first capacitor, the second energy storage circuit includes a second capacitor, the data writing-in circuit includes a writing-in transistor, the on-off control circuit includes an on-off control transistor, and the first initialization circuit includes a first initialization transistor;
a first terminal of the first capacitor is electrically connected to the third node, and a second terminal of the first capacitor is electrically connected to the fourth node;
a first terminal of the second capacitor is electrically connected to the fourth node, and a second terminal of the second capacitor is electrically connected to the fifth node;
a gate electrode of the writing-in transistor is electrically connected to the scanning terminal, a first electrode of the writing-in transistor is electrically connected to the data line, and a second electrode of the writing-in transistor is electrically connected to the fifth node;
a gate electrode of the on-off control transistor is electrically connected to the second light emitting control terminal, a first electrode of the on-off control transistor is electrically connected to the first node, and a second electrode of the on-off control transistor is electrically connected to the fifth node;
a gate electrode of the first initialization transistor is electrically connected to the first reset control terminal, a first electrode of the first initialization transistor is electrically connected to the first initial voltage terminal, and a second electrode of the first initialization transistor is electrically connected to the first node.

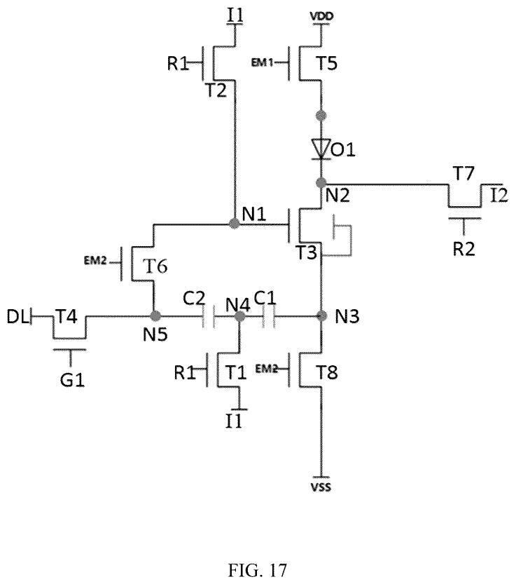

As shown in FIG. 17, based on at least one embodiment of the pixel circuit shown in FIG. 13, the driving circuit includes a driving transistor T3, the first light emitting control circuit includes a first light emitting control transistor T5; the second light emitting control circuit includes a second light emitting control transistor T8; the light emitting element is an organic light emitting diode O1;

The gate electrode of the driving transistor T3 is electrically connected to the first node N1, the drain electrode of the driving transistor T3 is electrically connected to the second node N2, and the source electrode of the driving transistor T3 is electrically connected to the third node N3;

The gate electrode of the first light emitting control transistor T5 is electrically connected to the first light emitting control terminal EM1, the source electrode of the first light emitting control transistor T5 is electrically connected to the anode of O1, and the drain electrode of the first light emitting control transistor T5 is electrically connected to the high voltage line VDD; the anode of O1 is electrically connected to the second node N2.

The gate electrode of the second light emitting control transistor T8 is electrically connected to the second light emitting control terminal EM2, the drain electrode of the second light emitting control transistor T8 is electrically connected to the third node N3, and the source electrode of the second light emitting control transistor T8 is electrically connected to the low voltage line VSS;

The first energy storage circuit includes a first capacitor C1, the second energy storage circuit includes a second capacitor C2, the data writing-in circuit includes a writing-in transistor T4, the on-off control circuit includes an on-off control transistor T6, and the first initialization circuit includes a first initialization transistor T2;

The first terminal of the first capacitor C1 is electrically connected to the third node N3, and the second terminal of the first capacitor C1 is electrically connected to the fourth node N4;

The first terminal of the second capacitor C2 is electrically connected to the fourth node N4, and the second terminal of the second capacitor C2 is electrically connected to the fifth node N5;

The gate electrode of the writing-in transistor T4 is electrically connected to the scanning terminal G1, the drain electrode of the write transistor T4 is electrically connected to the data line DL, and the source electrode of the write transistor T4 is electrically connected to the fifth node N5;

The gate electrode of the on-off control transistor T6 is electrically connected to the second light emitting control terminal EM2, the drain electrode of the on-off control transistor T6 is electrically connected to the first node N1, and the source electrode of the on-off control transistor T6 is electrically connected to the fifth node N5;

The gate electrode of the first initialization transistor T2 is electrically connected to the first reset control terminal R1, and the drain electrode of the first initialization transistor T2 is electrically connected to the first initialization voltage terminal I1, and the source electrode of the first initialization transistor T2 is electrically connected to the first node N1;

The second initialization circuit includes a second initialization transistor T1;

The gate electrode of the second initialization transistor T1 is electrically connected to the first reset control terminal R1, the drain electrode of the second initialization transistor T1 is electrically connected to the first initialization voltage terminal I1, and the source electrode of the second initialization transistor T1 is electrically connected to the fourth node N4;

The third initialization circuit includes a third initialization transistor T7;

The gate electrode of the third initialization transistor T7 is electrically connected to the second reset control terminal R2, the drain electrode of the third initialization transistor T7 is electrically connected to the second initial voltage terminal 12, and the source electrode of the third initialization transistor T7 is electrically connected to the second node N2;

The cathode of Ol is electrically connected to the second node N2.

In at least one embodiment of the pixel circuit shown in FIG. 17, all transistors are n-type transistors, and the pixel circuit is an oxide pixel circuit.

In at least one embodiment of the pixel circuit shown in FIG. 17, the voltage value of Vi1 can be greater than or equal to 0V and less than or equal to 6V;

The absolute value of the difference between the voltage value of the high voltage signal provided by VDD and the voltage value of the second initial voltage Vi2 is less than the turn-on voltage of O1, so that O1 does not emit light during the set time period.

In at least one embodiment of the pixel circuit shown in FIG. 17, T3 can be a dual-gate transistor, the first gate electrode of T3 is electrically connected to the first node N1, and the second gate electrode of T3 is electrically connected to the source electrode of T3.

In at least one embodiment of the pixel circuit shown in FIG. 17, the capacitance value of C1 is greater than the capacitance value of C3, and the capacitance value of C2 is greater than the capacitance value of C3.

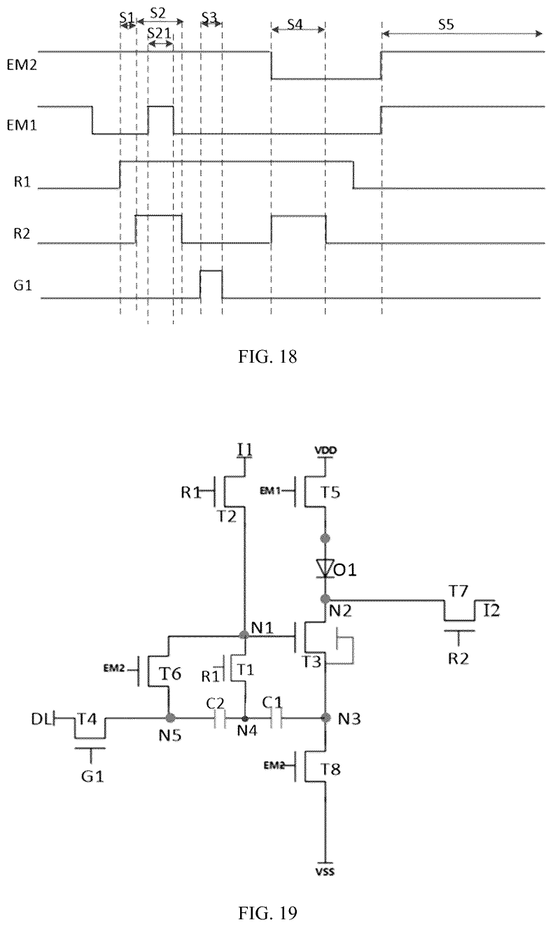

As shown in FIG. 18, when at least one embodiment of the pixel circuit shown in FIG. 17 of the present disclosure is working, the display period may include an initialization phase S1, a reset phase S2, a writing-in phase S3, a compensation phase S4 and a light emitting phase S5 which are successively set; the reset phase S2 includes a setting time period S21;

In the initialization phase S1, EM2 provides a high voltage signal, EM1 provides a low voltage signal, R1 provides a high voltage signal, R2 provides a low voltage signal, G1 provides a low voltage signal, T6 and T8 are turned on, and T1 and T2 are turned on to write the first initial voltage Vi1 provided by the first initial voltage terminal I1 into the first node N1, the fourth node N4 and the fifth node N5;

In the reset phase S2, EM2 provides a high voltage signal, R1 provides a high voltage signal, R2 provides a high voltage signal, G1 provides a low voltage signal, T6 and T8 are turned on, T1 and T2 are turned on, and T7 is turned on to write Vi1 into the first node N1, the fourth node N4 and the fifth node N5, and write the second initial voltage Vi2 provided by the second initial voltage terminal 12 into the second node N2;

In the set time period S21, EM1 provides a high voltage signal, and T5 is turned on to control the anode of O1 to be electrically connected to the high voltage line VDD to reset the potential of anode of O1;

In the writing-in phase S3, EM2 provides a high voltage signal, EM1 provides a low voltage signal, R1 provides a high voltage signal, R2 provides a low voltage signal, G1 provides a high voltage signal, DL provides a data voltage Vdata, T4 is turned on, T6 is turned on, to write the data voltage Vdata into the fifth node N5; T1 and T2 are turned on; T8 is turned on;

In the compensation phase S4, EM2 provides a low voltage signal, EM1 provides a low voltage signal, R1 provides a high voltage signal, R2 provides a high voltage signal, T8 is turned off, T2 is turned on, T1 is turned on, T7 is turned on, Vi2 charges C1 and C2 to control the potential of N3 to become Vi1-Vth for threshold voltage compensation; Vth is the threshold voltage of T3;

In the light emitting phase S5, EM2 provides a high voltage signal, EM1 provides a high voltage signal, R1 provides a low voltage signal, R2 provides a low voltage signal, G1 provides a low voltage signal, T5 and T8 are turned on, and T6 is turned on, so that the potential of N1 is Vdata, and the gate-source voltage of T3 is Vdata−Vi1+Vth, then the current value of the driving current flowing through O1 is K×(Vdata−Vi1)²; K is the current coefficient of T3.

As shown in FIG. 18, when at least one embodiment of the pixel circuit shown in FIG. 17 of the present disclosure is working, in the setting time period S21, T5 is turned on, T7 is turned on, the anode of O1 is connected to VDD, and the cathode of O1 is electrically connected to 12 to clear the residual charge at the two electrodes of O1, and the absolute value of the difference between the voltage value of the high voltage signal provided by VDD and the voltage value of the second initial voltage Vi2 is set to be less than the turn-on voltage of O1, so that O1 does not emit light in the setting time period.

As shown in FIG. 18, the duration of the reset stage S2 can be greater than the duration of the setting time period S21, so that at the beginning of the reset stage S2, T5 is not turned on to prevent O1 from emitting light.

The difference between at least one embodiment of the pixel circuit shown in FIG. 19 and at least one embodiment of the pixel circuit shown in FIG. 17 is that:

The drain electrode of T1 is electrically connected to the first node N1.

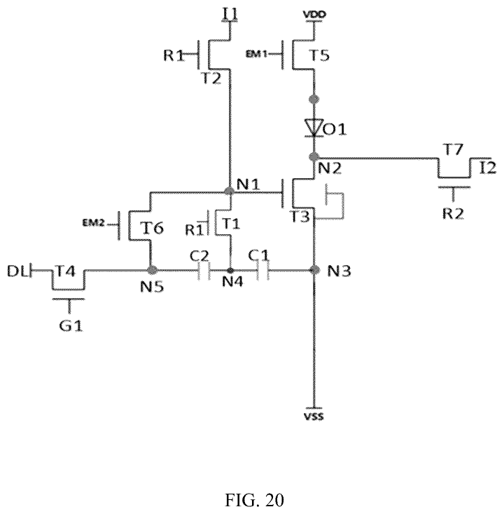

The difference between at least one embodiment of the pixel circuit shown in FIG. 20 and at least one embodiment of the pixel circuit shown in FIG. 19 is that: T8 is not included.

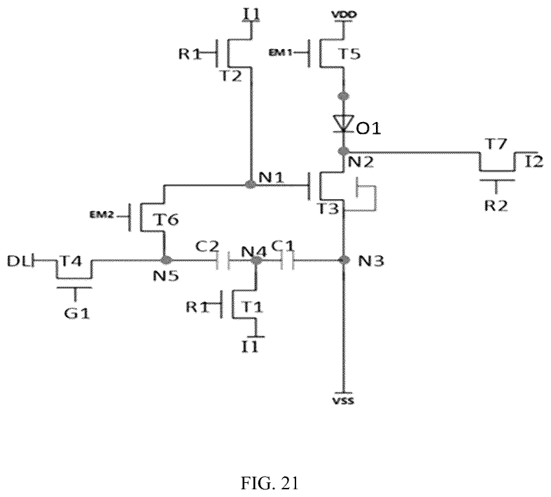

The difference between at least one embodiment of the pixel circuit shown in FIG. 21 and at least one embodiment of the pixel circuit shown in FIG. 17 is that T8 is not included.

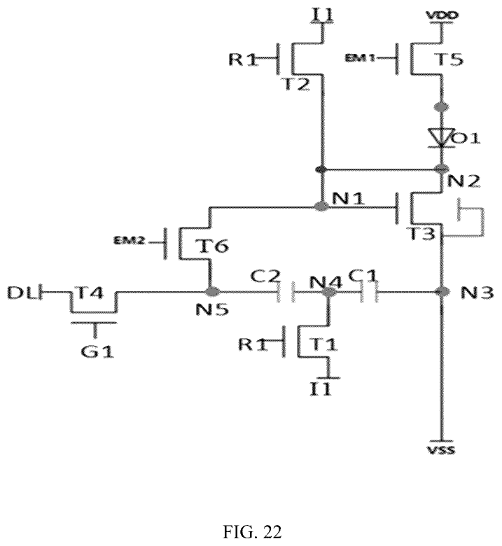

The difference between at least one embodiment of the pixel circuit shown in FIG. 22 and at least one embodiment of the pixel circuit shown in FIG. 21 is that T7 is not included; the first node N1 is electrically connected to the second node N2.

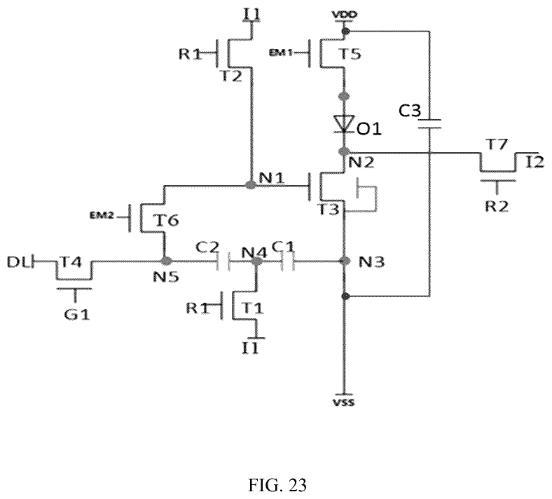

The difference between at least one embodiment of the pixel circuit shown in FIG. 23 and at least one embodiment of the pixel circuit shown in FIG. 21 is that a third energy storage circuit is further included;

The third energy storage circuit includes a third capacitor C3;

The first terminal of the third capacitor C3 is electrically connected to the low voltage line VSS, and the second terminal of the third capacitor C3 is electrically connected to the high voltage line VDD.

The pixel circuit described in at least one embodiment of the present disclosure further includes a first energy storage circuit, a data writing-in circuit and a first initialization circuit;

The second terminal of the driving circuit is directly electrically connected to the third node;

The first terminal of the first energy storage circuit is electrically connected to the first node, and the second terminal of the first energy storage circuit is electrically connected to the third node, and the first energy storage circuit is configured to store electric energy;

The data writing-in circuit is electrically connected to the scanning terminal, the data line and the first node respectively, and is configured to write the data voltage provided by the data line into the first node under the control of the scanning signal provided by the scanning terminal;

The first initialization circuit is electrically connected to the first reset control terminal, the first initial voltage terminal and the first node respectively, and is configured to write the first initial voltage provided by the first initial voltage terminal into the first node under the control of the first reset control signal provided by the first reset control terminal.

In specific implementation, the pixel circuit may include a first energy storage circuit, a data writing-in circuit and a first initialization circuit; the data writing-in circuit writes the data voltage into the first node under the control of the scanning signal; the first initialization circuit writes the first initial voltage into the first node under the control of the first reset control signal to reset the potential of the first node.

Optionally, the first node is electrically connected to the second node.

In a specific implementation, the first node can be directly electrically connected to the second node to reset the potential of the second node while resetting the potential of the first node.

In at least one embodiment of the present disclosure, the pixel circuit also includes a third initialization circuit;

The third initialization circuit is electrically connected to the second reset control terminal, the second initial voltage terminal and the second node respectively, and is configured to write the second initial voltage provided by the second initial voltage terminal into the second node under the control of the second reset control signal provided by the second reset control terminal.

In a specific implementation, the pixel circuit may include a third initialization circuit, and the third initialization circuit writes the second initial voltage into the second node under the control of the second reset control signal.

Optionally, the second electrode of the light emitting element is electrically connected to the second node through the first light emitting control circuit; the pixel circuit also includes a fourth initialization circuit;

The fourth initialization circuit is electrically connected to the second reset control terminal, the second electrode of the light emitting element and the second initial voltage terminal respectively, and is configured to write the second initial voltage into the second electrode of the light emitting element under the control of the second reset control signal.

In a specific implementation, the pixel circuit may also include a fourth initialization circuit, and the fourth initialization circuit writes the second initial voltage into the second electrode of the light emitting element under the control of the second reset control signal.

The pixel circuit described in at least one embodiment of the present disclosure further includes a third energy storage circuit;
a first terminal of the third energy storage circuit is electrically connected to the DC voltage line, a second terminal of the third energy storage circuit is electrically connected to the third node, and the third energy storage circuit is configured to store electric energy.

In a specific implementation, the pixel circuit may further include a third energy storage circuit, the third energy storage circuit is electrically connected to the second voltage line and the third node respectively, and the third energy storage circuit is configured to store electric energy; the third energy storage circuit may optimize the data voltage range of the pixel circuit to achieve better driving of low grayscale image quality.

Optionally, the DC voltage line may be the second voltage line or the first voltage line, but is not limited thereto. In a specific implementation, the DC voltage line may also be other types of DC voltage lines.

Optionally, the first energy storage circuit includes a first capacitor, and the third energy storage circuit includes a third capacitor;
a first terminal of the first capacitor is electrically connected to the first node, and a second terminal of the first capacitor is electrically connected to the third node;
a first terminal of the third capacitor is electrically connected to the DC voltage line, and a second terminal of the third capacitor is electrically connected to the third node;
a capacitance value of the third capacitor is less than a capacitance value of the first capacitor.

In specific implementation, the first capacitor is configured to store the threshold voltage of the driving transistor, and the third capacitor is configured to optimize the Data Range of the pixel circuit. Therefore, in the case where the space occupied by the pixel circuit is limited, the capacitance value of the first capacitor is preferentially guaranteed, so the capacitance value of the third capacitor can be set to be smaller than the capacitance value of the first capacitor.

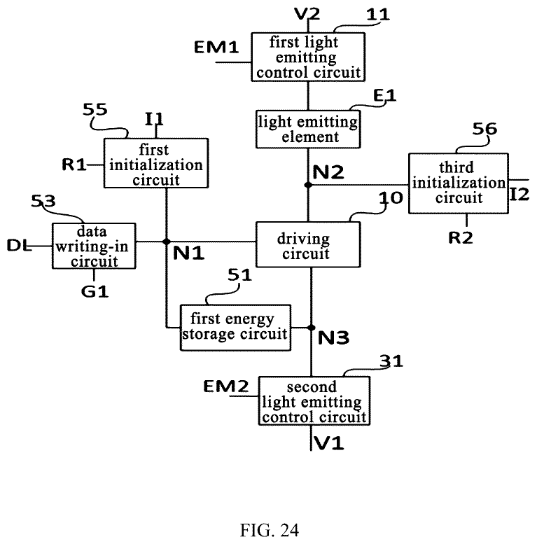

As shown in FIG. 24, based on at least one embodiment of the pixel circuit shown in FIG. 3, the pixel circuit described in at least one embodiment of the present disclosure further includes a first energy storage circuit 51, a data writing-in circuit 53, a first initialization circuit 55 and a third initialization circuit 56;

The second terminal of the driving circuit 10 is directly electrically connected to the third node N3;

The first terminal of the first energy storage circuit 51 is electrically connected to the first node N1, and the second terminal of the first energy storage circuit 51 is electrically connected to the third node N3, and the first energy storage circuit 51 is configured to store electric energy;

The data writing-in circuit 53 is electrically connected to the scanning terminal G1, the data line DL and the first node N1 respectively, and is configured to write the data line Vdata provided by the data line DL into the first node N1 under the control of the scanning signal provided by the scanning terminal G1;

The first initialization circuit 55 is electrically connected to the first reset control terminal R1, the first initial voltage terminal I1 and the first node N1 respectively, and is configured to write the first initial voltage provided by the first initial voltage terminal I1 into the first node N1 under the control of the first reset control signal provided by the first reset control terminal R1;

The third initialization circuit 56 is electrically connected to the second reset control terminal R2, the second initial voltage terminal 12 and the second node N2 respectively, and is configured to write the second initial voltage Vi2 provided by the second initial voltage terminal 12 into the second node N2 under the control of the second reset control signal provided by the second reset control terminal R2.

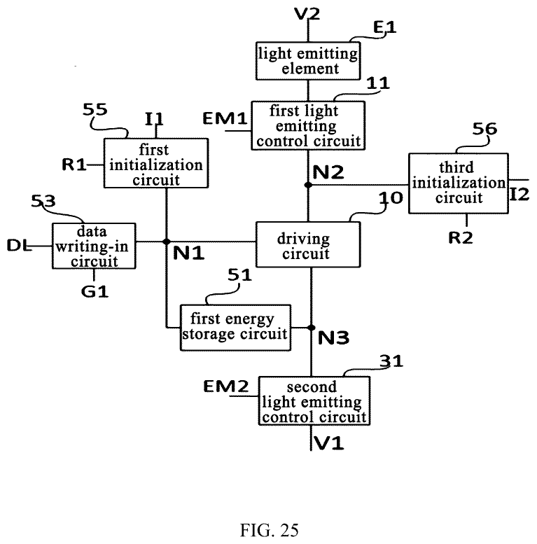

As shown in FIG. 25, based on at least one embodiment of the pixel circuit shown in FIG. 4, the pixel circuit described in at least one embodiment of the present disclosure further includes a first energy storage circuit 51, a data writing-in circuit 53, a first initialization circuit 55 and a third initialization circuit 56;

The second terminal of the driving circuit 10 is directly electrically connected to the third node N3;

The first terminal of the first energy storage circuit 51 is electrically connected to the first node N1, and the second terminal of the first energy storage circuit 51 is electrically connected to the third node N3, and the first energy storage circuit 51 is configured to store electric energy;

The data writing-in circuit 53 is electrically connected to the scanning terminal G1, the data line DL and the first node N1 respectively, and is configured to write the data voltage Vdata provided by the data line DL into the first node N1 under the control of the scanning signal provided by the scanning terminal G1;

The first initialization circuit 55 is electrically connected to the first reset control terminal R1, the first initial voltage terminal Il and the first node N1 respectively, and is configured to write the first initial voltage provided by the first initial voltage terminal Il into the first node N1 under the control of the first reset control signal provided by the first reset control terminal R1;

The third initialization circuit 56 is electrically connected to the second reset control terminal R2, the second initial voltage terminal 12 and the second node N2 respectively, and is configured to write the second initial voltage Vi2 provided by the second initial voltage terminal 12 into the second node N2 under the control of the second reset control signal provided by the second reset control terminal R2.

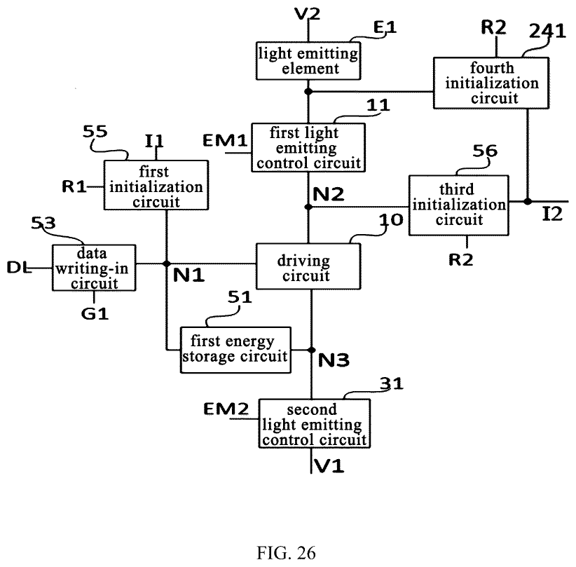

As shown in FIG. 26, based on at least one embodiment of the pixel circuit shown in FIG. 25, the pixel circuit described in at least one embodiment of the present disclosure further includes a fourth initialization circuit 241;

The fourth initialization circuit 241 is electrically connected to the second reset control terminal R2, the second electrode of the light emitting element E1 and the second initial voltage terminal 12 respectively, and is configured to write the second initial voltage Vi2 into the second electrode of the light emitting element E1 under the control of the second reset control signal.

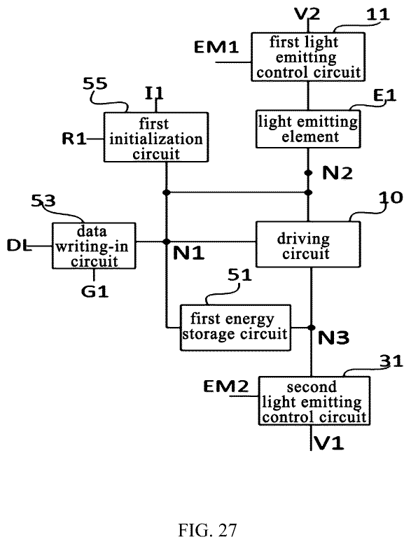

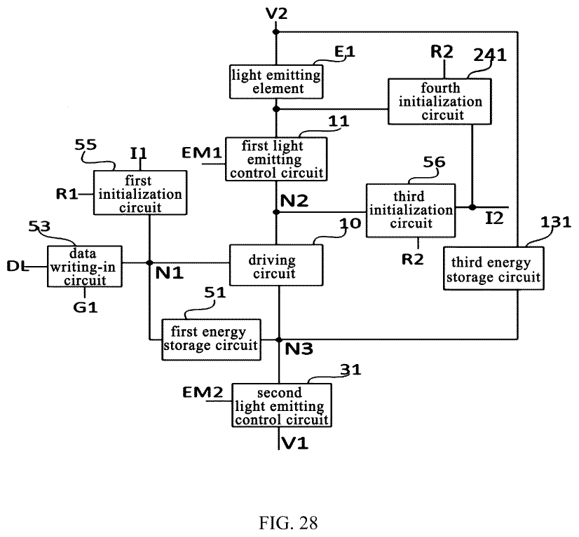

The difference between at least one embodiment of the pixel circuit shown in FIG. 27 and at least one embodiment of the pixel circuit shown in FIG. 24 is as follows:

The third initialization circuit 56 is not included;

The first node N1 is electrically connected to the second node N2.

As shown in FIG. 28, based on at least one embodiment of the pixel circuit shown in FIG. 26, the pixel circuit described in at least one embodiment of the present disclosure further includes a third energy storage circuit 131;

The first terminal of the third energy storage circuit 131 is electrically connected to the first voltage line V1, and the second terminal of the third energy storage circuit 131 is electrically connected to the third node N3, and the third energy storage circuit 131 is configured to store electrical energy.

Optionally, the first energy storage circuit includes a first capacitor, the data writing-in circuit includes a writing-in transistor, and the first initialization circuit includes a first initialization transistor;

The first terminal of the first capacitor is electrically connected to the first node, and the second terminal of the first capacitor is electrically connected to the third node;

The gate electrode of the writing-in transistor is electrically connected to the scanning terminal, the first electrode of the writing-in transistor is electrically connected to the data line, and the second electrode of the writing-in transistor is electrically connected to the first node;

The gate electrode of the first initialization transistor is electrically connected to the first reset control terminal, the first electrode of the first initialization transistor is electrically connected to the first initial voltage terminal, and the second electrode of the first initialization transistor is electrically connected to the first node.

In at least one embodiment of the present disclosure, the absolute value of the difference between the voltage value of the second voltage signal provided by the second voltage line and the voltage value of the second initial voltage is less than the turn-on voltage of the light emitting element, so that the light emitting element does not emit light in the reset phase.

In at least one embodiment of the present disclosure, the display period of the pixel circuit includes a reset phase and a light emitting phase which are successively arranged; the reset phase includes a set time period;

The third initialization circuit is configured to write the second initial voltage into the second node under the control of the second reset control signal in the reset phase;

The first light emitting control circuit is configured to control to connect the first electrode of the light emitting element and the second voltage line, or to control to connect the second electrode of the light emitting element and the second node under the control of the first light emitting control signal in the set time period.

In specific implementation, during the set time period, the third initialization circuit writes the second initial voltage into the second node under the control of the second reset control signal, and the first light emitting control circuit controls the first electrode of the light emitting element to be connected to the second voltage line, or controls the second electrode of the light emitting element to be connected to the second node under the control of the first light emitting control signal, so as to reset the potential of the first electrode of the light emitting element and the potential of the second electrode of the light emitting element, clear the charge stored in the two electrodes of the light emitting element, and during the set time period, by setting the potential of the first electrode of the light emitting element and the potential of the second electrode of the light emitting element, control the light emitting element not to emit light.

In at least one embodiment of the present disclosure, the duration of the reset phase is greater than the duration of the set time period, so that the light emitting element does not emit light during the reset phase.

In at least one embodiment of the present disclosure, the display period also includes an initialization phase arranged before the reset phase, and a writing-in phase and a compensation phase arranged between the reset phase and the light emitting phase, wherein the writing-in phase and the compensation phase are arranged successively;

The first initialization circuit is configured to write the first initial voltage into the first node under the control of the first reset control signal during the initialization phase, the reset phase, the writing-in phase and the compensation phase;

The third initialization circuit is configured to write the second initial voltage into the second node under the control of the second reset control signal during the compensation phase;

The data writing-in circuit is configured to write the data voltage provided by the data line into the first node under the control of the scanning signal during the writing-in phase;

The first light emitting control circuit is configured to control to connect the first electrode of the light emitting element and the second voltage line, or to control to connect the second electrode of the light emitting element and the second node under the control of the first light emitting control signal during the light emitting phase.

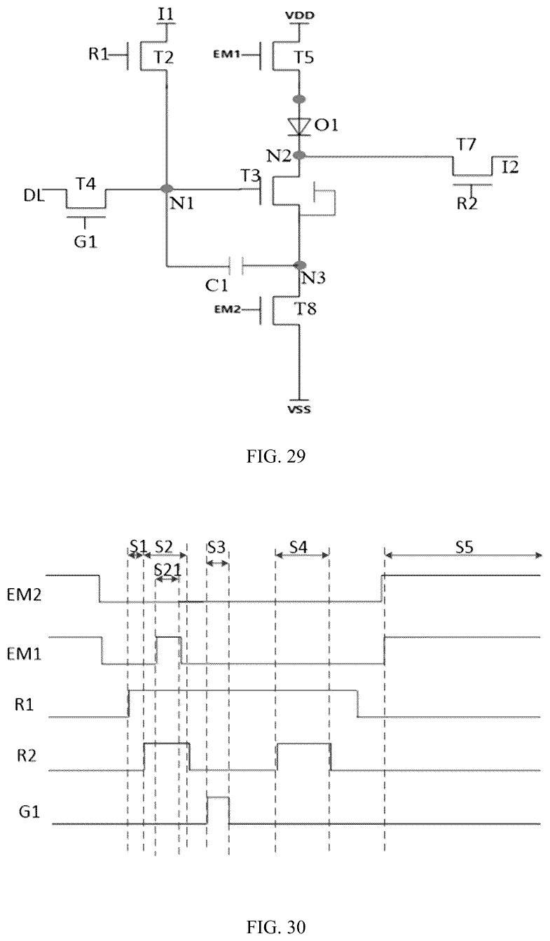

As shown in FIG. 29, based on at least one embodiment of the pixel circuit shown in FIG. 24, the driving circuit includes a driving transistor T3, the first light emitting control circuit includes a first light emitting control transistor T5; the second light emitting control circuit includes a second light emitting control transistor T8; the light emitting element is an organic light emitting diode O1;

The gate electrode of the driving transistor T3 is electrically connected to the first node N1, the drain electrode of the driving transistor T3 is electrically connected to the second node N2, and the source electrode of the driving transistor T3 is electrically connected to the third node N3;

The gate electrode of the first light emitting control transistor T5 is electrically connected to the first light emitting control terminal EM1, the source electrode of the first light emitting control transistor T5 is electrically connected to the anode of O1, and the drain electrode of the first light emitting control transistor T5 is electrically connected to the high voltage line VDD; the cathode of O1 is electrically connected to the second node N2;

The gate electrode of the second light emitting control transistor T8 is electrically connected to the second light emitting control terminal EM2, the drain electrode of the second light emitting control transistor T8 is electrically connected to the third node N3, and the source electrode of the second light emitting control transistor T8 is electrically connected to the low voltage line VSS;

The first energy storage circuit includes a first capacitor C1, the data writing-in circuit includes a data writing-in transistor T4, the first initialization circuit includes a first initialization transistor T2, and the third initialization circuit includes a third initialization transistor T7;

The first terminal of C1 is electrically connected to the first node N1, and the second terminal of C1 is electrically connected to the third node N3;

The gate electrode of T4 is electrically connected to the scanning terminal G1, the drain electrode of T4 is electrically connected to the data line DL, and the source electrode of T4 is electrically connected to the first node N1;

The gate electrode of T2 is electrically connected to the first reset control terminal R1, the drain electrode of T2 is electrically connected to the first initial voltage terminal I1, and the source electrode of T2 is electrically connected to the first node N1; the first initial voltage terminal I1 is configured to provide the first initial voltage Vi1;

The gate electrode of T7 is electrically connected to the second reset control terminal R2, the drain electrode of T7 is electrically connected to the second initial voltage terminal 12, and the source electrode of T7 is electrically connected to the second node N2; the second initial voltage terminal 12 is configured to provide the second initial voltage Vi2.

In at least one embodiment of the pixel circuit shown in FIG. 29, all transistors are n-type transistors, and the pixel circuit is an oxide pixel circuit.

In at least one embodiment of the pixel circuit shown in FIG. 29, the voltage value of Vi1 may be greater than or equal to 0V and less than or equal to 6V;

The absolute value of the difference between the voltage value of the high voltage signal provided by VDD and the voltage value of the second initial voltage Vi2 is less than the turn-on voltage of O1, so that O1 does not emit light during the set time period.

In at least one embodiment of the pixel circuit shown in FIG. 29, T3 may be a dual-gate transistor, the first gate electrode of T3 is electrically connected to the first node N1, and the second gate electrode of T3 is electrically connected to the source electrode of T3.

In at least one embodiment of the pixel circuit shown in FIG. 29, the capacitance value of C1 is greater than the capacitance value of C3.

As shown in FIG. 30, when at least one embodiment of the pixel circuit shown in FIG. 29 of the present disclosure is in operation, the display period may include an initialization phase S1, a reset phase S2, a writing-in phase S3, a compensation phase S4 and a light emitting phase S5 which are successively set; the reset phase S2 includes a setting time period S21;

In the initialization phase S1, EM2 provides a low voltage signal, EM1 provides a low voltage signal, R1 provides a high voltage signal, R2 provides a low voltage signal, G1 provides a low voltage signal, and T2 is turned on to write Vi1 into the first node N1 ;

In the reset phase S2, EM2 provides a low voltage signal, R1 provides a high voltage signal, R2 provides a high voltage signal, G1 provides a low voltage signal, T2 is turned on to write Vi1 into the first node N1, T7 is turned on to write Vi2 into the second node N2;

In the set time period S21, EM1 provides a high voltage signal, T5 is turned on to control to connect the high voltage line VDD and the anode of O1;

In the writing-in phase S3, EM2 provides a low voltage signal, EM1 provides a low voltage signal, R1 provides a high voltage signal, R2 provides a low voltage signal, G1 provides a high voltage signal, T2 is turned on to write Vil into the first node N1, T4 is turned on, DL provides the data voltage Vdata, and writes the data voltage Vdata into the first node N1;

In the compensation phase S4, EM2 provides a low voltage signal, EM1 provides a low voltage signal, R1 provides a high voltage signal, R2 provides a high voltage signal, G1 provides a low voltage signal, T2 is turned on to write Vi1 into the first node N1, T7 is turned on, and C1 is charged through Vi2 until the potential of N3 is Vi1-Vth, Vth is the threshold voltage of T3;

In the light emitting phase S5, EM2 provides a high voltage signal, EM1 provides a high voltage signal, R1 provides a low voltage signal, R2 provides a low voltage type, G1 provides a low voltage signal, T5 and T8 are turned on, T3 drives O1 to emit light, T6 is turned on to write Vdata into the first node N1, the gate-source voltage of T3 is Vdata−Vi1+Vth, and the current value of the driving current flowing through O1 is K×(Vdata−Vi1)²; K is the current coefficient of T3.

As shown in FIG. 30, when at least one embodiment of the pixel circuit shown in FIG. 29 of the present disclosure is working, in the setting time period S21, T5 is turned on, T7 is turned on, the anode of O1 is connected to VDD, and the cathode of O1 is electrically connected to 12 to clear the residual charge at the two electrodes of O1, and the absolute value of the difference between the voltage value of the high voltage signal provided by VDD and the voltage value of the second initial voltage Vi2 is set to be less than the turn-on voltage of O1, so that O1 does not emit light in the setting time period.

As shown in FIG. 30, the duration of the reset phase S2 may be greater than the duration of the set time period S21, so that at the beginning of the reset phase S2, T5 is not turned on to prevent O1 from emitting light.

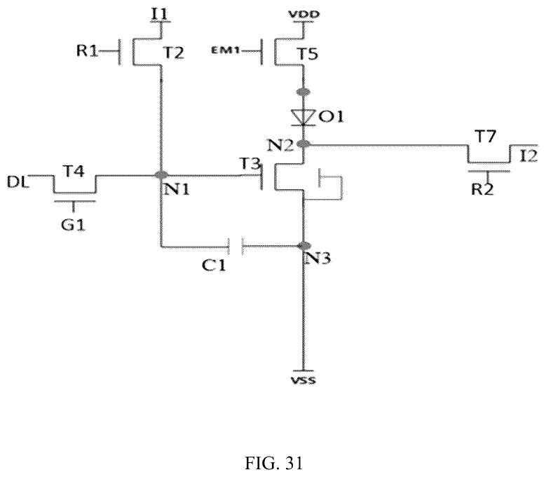

The difference between at least one embodiment of the pixel circuit shown in FIG. 31 of the present disclosure and at least one embodiment of the pixel circuit shown in FIG. 29 of the present disclosure is that T8 is not included.

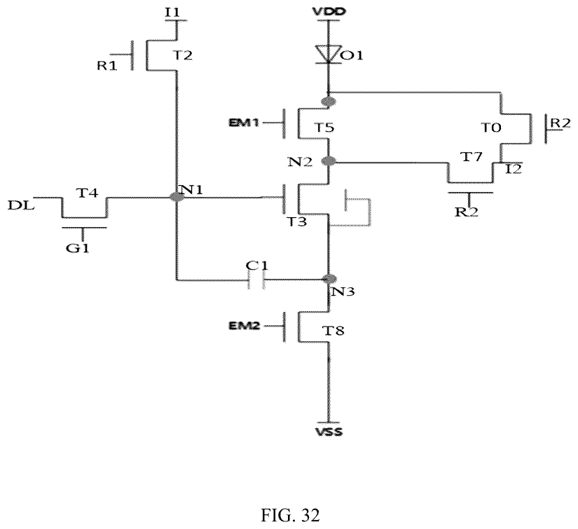

The difference between at least one embodiment of the pixel circuit shown in FIG. 32 of the present disclosure and at least one embodiment of the pixel circuit shown in FIG. 29 of the present disclosure is that a fourth initialization circuit is also included;

The fourth initialization circuit includes a fourth initialization transistor T0;

The gate electrode of T0 is electrically connected to the second reset control terminal R2, the drain electrode of T0 is electrically connected to the cathode of O1, and the source electrode of T0 is electrically connected to the second initial voltage terminal 12;

The second initial voltage terminal 12 is configured to provide a second initial voltage Vi2.

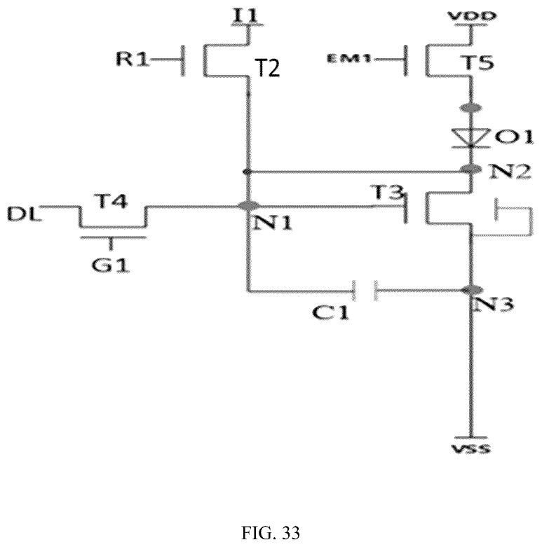

The difference between at least one embodiment of the pixel circuit shown in FIG. 33 of the present disclosure and at least one embodiment of the pixel circuit shown in FIG. 31 of the present disclosure is that the first node N1 is electrically connected to the second node N2.

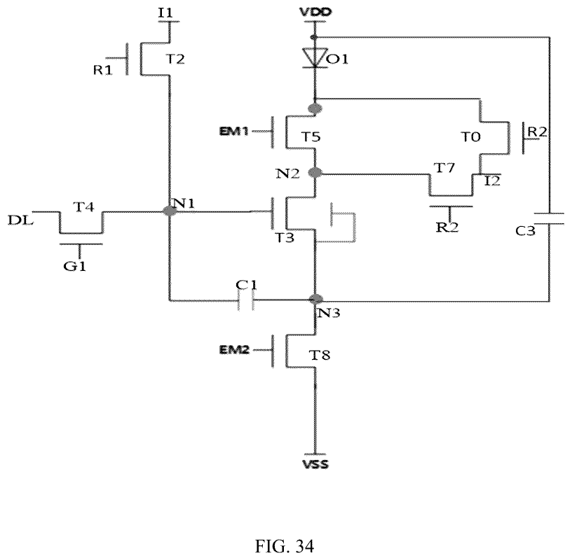

The difference between at least one embodiment of the pixel circuit shown in FIG. 34 of the present disclosure and at least one embodiment of the pixel circuit shown in FIG. 32 of the present disclosure is that: a third energy storage circuit is further included;

The third energy storage circuit includes a third capacitor C3;

The first terminal of the third capacitor C3 is electrically connected to the high voltage line VDD, and the second terminal of the third capacitor C3 is electrically connected to the third node N3.

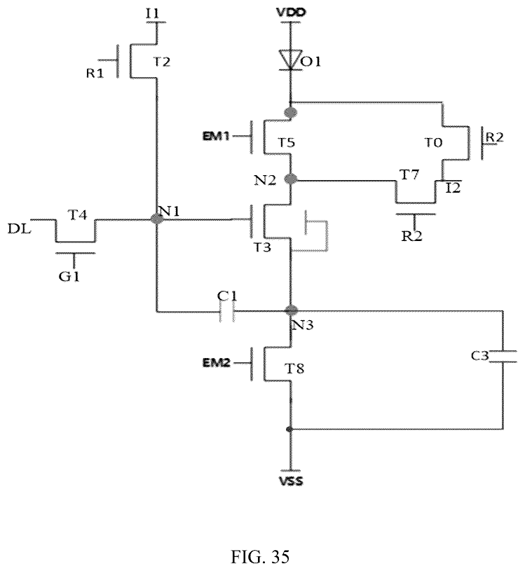

The difference between at least one embodiment of the pixel circuit shown in FIG. 35 of the present disclosure and at least one embodiment of the pixel circuit shown in FIG. 34 of the present disclosure is that:

The first terminal of C3 is electrically connected to the low voltage line VSS, and the second terminal of C3 is electrically connected to the third node N3.

The pixel driving method described in the embodiment of the present disclosure is applied to the above-mentioned pixel circuit, and the pixel driving method includes:

Controlling, by the driving circuit, to generate a driving current under the control of the potential of the first node;

Controlling, by the first light emitting control circuit, to connect or disconnect the first electrode of the light emitting element and the second voltage line under the control of the first light emitting control signal; or, controlling, by the first light emitting control circuit, to connect or disconnect the second electrode of the light emitting element and the second node under the control of the first light emitting control signal.

The display device described in the embodiment of the present disclosure includes a base substrate and the above-mentioned pixel circuit arranged on the base substrate.

The display device described in at least one embodiment of the present disclosure includes a first voltage line and a plurality of metal layers arranged on the base substrate;

The transistor in the pixel circuit is arranged in the metal layer;

At least part of the first voltage line is formed in the metal layer.

In at least one embodiment of the present disclosure, the first voltage line can be a low voltage line, and the second voltage line can be a high voltage line, but it is not limited thereto.

In the related art, the low voltage line is routed through the cathode layer. Due to the large cathode resistance, the IR voltage drop of the low voltage line is large. When the pixel circuit is working, the source voltage of the driving transistor is unstable, which causes the display brightness to change. In at least one embodiment of the present disclosure, at least part of the first voltage line is formed in the metal layer to reduce the resistance of the first voltage line and the IR voltage drop of the first voltage line.

The display device described in at least one embodiment of the present disclosure also includes a first electrode layer, a light emitting material layer and a second electrode layer;

The first electrode layer, the light emitting material layer and the second electrode layer are arranged in sequence along the direction in which the metal layer is away from the base substrate;

The first electrode of the light emitting element is formed in the second electrode layer, and the second electrode of the light emitting element is formed in the first electrode layer;

A part of the first voltage line is formed in the first electrode layer.

In a specific implementation, the display device may include a first electrode layer, a light emitting material layer, and a second electrode layer, and the first electrode layer, the light emitting material layer, and the second electrode layer are arranged in sequence along the direction in which the metal layer is away from the base substrate. In at least one embodiment of the present disclosure, the light emitting element may be reversed, and the setting position of the first voltage line and the setting position of the second voltage line may be interchanged, that is, a part of the first voltage line is set in the first electrode layer, and a part of the first voltage line may be set in at least one of the gate metal layer, the first source-drain metal layer, and the second metal layer, and the second voltage line is set in the second electrode layer, and the first electrode of the light emitting element is set in the second electrode layer, and the second electrode of the light emitting element is set in the first electrode layer. By reversing the pixels, the first voltage line is used for in-plane routing, the voltage fluctuation of the first voltage signal is reduced, and the screen uniformity of the pixel circuit is improved.

In at least one embodiment of the present disclosure, the first electrode layer may be set as a whole layer, and the second electrode layer may include a plurality of independent electrode patterns.

The above descriptions are implementations of the present disclosure. It should be pointed out that those skilled in the art can make some improvements and modifications without departing from the principle of the present disclosure. These improvements and modifications shall also fall within the scope of the present disclosure.

1. A pixel circuit, comprising a driving circuit, a first light emitting control circuit and a light emitting element; wherein
a control terminal of the driving circuit is electrically connected to a first node, a first terminal of the driving circuit is electrically connected to a second node, a second terminal of the driving circuit is electrically connected to a first voltage line, and the driving circuit is configured to control to generate a driving current under the control of a potential of the first node;
a first electrode of the light emitting element is electrically connected to a second voltage line through the first light emitting control circuit, and a second electrode of the light emitting element is electrically connected to the second node, the first light emitting control circuit is configured to control to connect or disconnect the first electrode of the light emitting element and the second voltage line under the control of a first light emitting control signal provided by the first light emitting control terminal; or, the first electrode of the light emitting element is electrically connected to the second voltage line, and the second electrode of the light emitting element is electrically connected to the second node through the first light emitting control circuit, the first light emitting control circuit is configured to control to connect or disconnect the second electrode of the light emitting element and the second node under the control of the first light emitting control signal.

2. The pixel circuit according to claim 1, further comprising a second light emitting control circuit; wherein
the second terminal of the driving circuit is electrically connected to the first voltage line through the second light emitting control circuit;
the second light emitting control circuit is electrically connected to the second light emitting control terminal, and is configured to control to connect or disconnect the second terminal of the driving circuit and the first voltage line under the control of a second light emitting control signal provided by the second light emitting control terminal.

3. The pixel circuit according to claim 1, further comprising a first energy storage circuit, a second energy storage circuit, a data writing-in circuit, an on-off control circuit and a first initialization circuit; wherein
the second terminal of the driving circuit is directly electrically connected to a third node;
a first terminal of the first energy storage circuit is electrically connected to the third node, a second terminal of the first energy storage circuit is electrically connected to a fourth node, a first terminal of the second energy storage circuit is electrically connected to the fourth node, a second terminal of the second energy storage circuit is electrically connected to a fifth node, and the first energy storage circuit and the second energy storage circuit are configured to store electric energy;
the data writing-in circuit is electrically connected to a scanning terminal, a data line and the fifth node respectively, and is configured to write a data voltage provided by the data line into the fifth node under the control of a scanning signal provided by the scanning terminal;
the on-off control circuit is electrically connected to the second light emitting control terminal, the first node and the fifth node respectively, and is configured to control to connect or disconnect the first node and the fifth node under the control of the second light emitting control signal;
the first initialization circuit is electrically connected to a first reset control terminal, a first initial voltage terminal and the first node respectively, and is configured to write a first initial voltage provided by the first initial voltage terminal into the first node under the control of a first reset control signal provided by the first reset control terminal.

4. The pixel circuit according to claim 3, further comprising a second initialization circuit; wherein
the second initialization circuit is electrically connected to the first reset control terminal, the first initial voltage terminal and the fourth node respectively, and is configured to write the first initial voltage into the fourth node under the control of the first reset control signal; or,
the second initialization circuit is electrically connected to the first reset control terminal, the first node and the fourth node respectively, and is configured to control to connect or disconnect the first node and the fourth node under the control of the first reset control signal.

5. The pixel circuit according to claim 4, further comprising a third initialization circuit; wherein
the third initialization circuit is electrically connected to a second reset control terminal, a second initial voltage terminal and the second node, respectively, and is configured to write a second initial voltage provided by the second initial voltage terminal into the second node under the control of a second reset control signal provided by the second reset control terminal.

6. The pixel circuit according to claim 4, further comprising a third energy storage circuit; wherein
a first terminal of the third energy storage circuit is electrically connected to the first voltage line, a second terminal of the third energy storage circuit is electrically connected to the second voltage line, and the third energy storage circuit is configured to store electrical energy,
wherein the third energy storage circuit includes a third capacitor, the first energy storage circuit includes a first capacitor, and the second energy storage circuit includes a second capacitor;
a first terminal of the first capacitor is electrically connected to the third node, and a second terminal of the first capacitor is electrically connected to the fourth node;
a first terminal of the second capacitor is electrically connected to the fourth node, and a second terminal of the second capacitor is electrically connected to the fifth node;
a first terminal of the third capacitor is electrically connected to the first voltage line. and a second terminal of the third capacitor is electrically connected to the second voltage line;
a capacitance value of the third capacitor is less than a capacitance value of the first capacitor, and the capacitance value of the third capacitor is less than a capacitance value of the second capacitor.

7. (canceled)

8. The pixel circuit according to claim 5, wherein an absolute value of a difference between a voltage value of the second voltage signal provided by the second voltage line and a voltage value of the second initial voltage is smaller than an turn-on voltage of the light emitting element.

9. The pixel circuit according to claim 5, wherein a display period of the pixel circuit includes a reset phase and a light emitting phase that are successively arranged; the reset phase includes a set time period;
the first light emitting control circuit is configured to control to connect the first electrode of the light emitting element and the second voltage line, or to connect the second electrode of the light emitting element and the second node, under the control of the first light emitting control signal, during the light emitting phase;
the driving circuit is configured to control to generate a driving current to driving the light emitting element to emit light during the light emitting phase;
the third initialization circuit is configured to write the second initial voltage into the second node under the control of the second reset control signal during the reset phase;
the first light emitting control circuit is configured to control to connect the first electrode of the light emitting element and the second voltage line, or to connect the second electrode of the light emitting element and the second node, under the control of the first light emitting control signal, during the set time period.

10. The pixel circuit according to claim 9, wherein the display period further includes an initialization phase arranged before the reset phase, and a writing-in phase and a compensation phase arranged between the reset phase and the light emitting phase, the writing-in phase and the compensation phase are arranged successively;
the first initialization circuit is configured to write the first initial voltage into the first node under the control of the first reset control signal in the initialization phase, the reset phase, the writing-in phase and the compensation phase;
the on-off control circuit is configured to control to connect the first node and the fifth node under the control of the second light emitting control signal in the initialization phase, the reset phase, the writing-in phase and the light emitting phase;
the data writing-in circuit is configured to write the data voltage provided by the data line to the fifth node under the control of the scanning signal in the writing-in phase;
the third initialization circuit is configured to write the second initial voltage into the second node under the control of the second reset control signal in the compensation phase,
wherein the pixel circuit further includes a second initialization circuit; wherein the second initialization circuit is configured to write the first initial voltage into the fourth node under the control of the first reset control signal in the initialization phase, the reset phase, the writing-in phase and the compensation phase.

11. (canceled)

12. The pixel circuit according to claim 3, wherein the driving circuit includes a driving transistor, and the first light emitting control circuit includes a first light emitting control transistor;
a gate electrode of the driving transistor is electrically connected to the first node, a first electrode of the driving transistor is electrically connected to the second node, and a second electrode of the driving transistor is electrically connected to the first voltage line;
a gate electrode of the first light emitting control transistor is electrically connected to the first light emitting control terminal, a first electrode of the first light emitting control transistor is electrically connected to the first electrode of the light emitting element, and a second electrode of the first light emitting control transistor is electrically connected to the second voltage line; or, the gate electrode of the first light emitting control transistor is electrically connected to the first light emitting control terminal, the first electrode of the first light emitting control transistor is electrically connected to the second electrode of the light emitting element, and the second electrode of the first light emitting control transistor is electrically connected to the second node;
the first energy storage circuit includes a first capacitor, the second energy storage circuit includes a second capacitor, the data writing-in transistor includes a writing-in transistor, the on-off control circuit includes an on-off control transistor, the first initialization circuit includes a first initialization transistor;
a first terminal of the first capacitor is electrically connected to the third node, and a second terminal of the first capacitor is electrically connected to the fourth node;
a first terminal of the second capacitor is electrically connected to the fourth node, and a second terminal of the second capacitor is electrically connected to the fifth node;
a gate electrode of the writing-in transistor is electrically connected to the scanning terminal, a first electrode of the writing-in transistor is electrically connected to the data line, and a second electrode of the writing-in transistor is electrically connected to the fifth node;
a gate electrode of the on-off control transistor is electrically connected to the second light emitting control terminal, a first electrode of the on-off control transistor is electrically connected to the first node, and a second electrode of the on-off control transistor is electrically connected to the fifth node;
a gate electrode of the first initialization transistor is electrically connected to the first reset control terminal, a first electrode of the first initialization transistor is electrically connected to the first initial voltage terminal, and a second electrode of the first initialization transistor is electrically connected to the first node.

13. The pixel circuit according to claim 1, further comprising a first energy storage circuit, a data writing-in circuit and a first initialization circuit;
the second terminal of the driving circuit is directly electrically connected to the third node;
a first terminal of the first energy storage circuit is electrically connected to the first node, and a second terminal of the first energy storage circuit is electrically connected to the third node, and the first energy storage circuit is configured to store electric energy;
the data writing-in circuit is electrically connected to the scanning terminal, the data line and the first node respectively, and is configured to write the data voltage provided by the data line into the first node under the control of the scanning signal provided by the scanning terminal;
the first initialization circuit is electrically connected to the first reset control terminal, the first initial voltage terminal and the first node respectively, and is configured to write the first initial voltage provided by the first initial voltage terminal into the first node under the control of the first reset control signal provided by the first reset control terminal.

14. The pixel circuit according to claim 13, further comprising a third initialization circuit; wherein
the third initialization circuit is electrically connected to the second reset control terminal, the second initial voltage terminal and the second node respectively, and is configured to write the second initial voltage provided by the second initial voltage terminal into the second node under the control of the second reset control signal provided by the second reset control terminal,
wherein the second electrode of the light emitting element is electrically connected to the second node through the first light emitting control circuit; the pixel circuit further includes a fourth initialization circuit;
the fourth initialization circuit is electrically connected to the second reset control terminal, the second electrode of the light emitting element and the second initial voltage terminal respectively, and is configured to write the second initial voltage into the second electrode of the light emitting element under the control of the second reset control signal.

15. (canceled)

16. The pixel circuit according to claim 13, further comprising a third energy storage circuit;
a first terminal of the third energy storage circuit is electrically connected to a DC voltage line, a second terminal of the third energy storage circuit is electrically connected to the third node, and the third energy storage circuit is configured to store electric energy,
wherein the first energy storage circuit comprises a first capacitor, and the third energy storage circuit comprises a third capacitor;
a first terminal of the first capacitor is electrically connected to the first node, and a second terminal of the first capacitor is electrically connected to the third node;
a first terminal of the third capacitor is electrically connected to the DC voltage line, and a second terminal of the third capacitor is electrically connected to the third node;
a capacitance value of the third capacitor is less than a capacitance value of the first capacitor.

17. (canceled)

18. The pixel circuit according to claim 13, wherein the first energy storage circuit includes a first capacitor, the data writing-in circuit includes a writing-in transistor, and the first initialization circuit includes a first initialization transistor;
a first terminal of the first capacitor is electrically connected to the first node, and a second terminal of the first capacitor is electrically connected to the third node;
a gate electrode of the writing-in transistor is electrically connected to the scanning terminal, a first electrode of the writing-in transistor is electrically connected to the data line, and a second electrode of the writing-in transistor is electrically connected to the first node;
a gate electrode of the first initialization transistor is electrically connected to the first reset control terminal, a first electrode of the first initialization transistor is electrically connected to the first initial voltage terminal, and a second electrode of the first initialization transistor is electrically connected to the first node.

19. The pixel circuit according to claim 14, wherein an absolute value of a difference between a voltage value of the second voltage signal provided by the second voltage line and a voltage value of the second initial voltage is less than a turn-on voltage of the light emitting element.

20. The pixel circuit according to claim 14, wherein a display period of the pixel circuit includes a reset phase and a light emitting phase which are successively arranged; the reset phase includes a set time period;
the third initialization circuit is configured to write the second initial voltage into the second node under the control of the second reset control signal in the reset phase;
the first light emitting control circuit is configured to control to connect the first electrode of the light emitting element and the second voltage line, or to control to connect the second electrode of the light emitting element and the second node under the control of the first light emitting control signal in the set time period.

21. The pixel circuit according to claim 20, wherein the display period further includes an initialization phase arranged before the reset phase, and a writing-in phase and a compensation phase arranged between the reset phase and the light emitting phase, the writing-in phase and the compensation phase are arranged successively;
the first initialization circuit is configured to write the first initial voltage into the first node under the control of the first reset control signal during the initialization phase, the reset phase, the writing-in phase and the compensation phase;
the third initialization circuit is configured to write the second initial voltage into the second node under the control of the second reset control signal during the compensation phase;
the data writing-in circuit is configured to write the data voltage provided by the data line into the first node under the control of the scanning signal during the writing-in phase;
the first light emitting control circuit is configured to control to connect the first electrode of the light emitting element and the second voltage line, or to control to connect the second electrode of the light emitting element and the second node under the control of the first light emitting control signal during the light emitting phase.

22. A pixel driving method, applied to the pixel circuit according to claim 1, wherein the pixel driving method includes:
controlling, by the driving circuit, to generate the driving current under the control of the potential of the first node;
controlling, by the first light emitting control circuit, to connect or disconnect the first electrode of the light emitting element and the second voltage line under the control of the first light emitting control signal; or, controlling, by the first light emitting control circuit, to connect or disconnect the second electrode of the light emitting element and the second node under the control of the first light emitting control signal.

23. A display device, comprising a base substrate and the pixel circuit according to claim 1, arranged on the base substrate.

24. The display device according to claim 23, comprising a first voltage line and a plurality of metal layers arranged on the base substrate; wherein
a transistor in the pixel circuit is arranged on the metal layer;
at least part of the first voltage line is formed on the metal layer,
wherein the display device further includes a first electrode layer, a light emitting material layer and a second electrode layer; wherein
the first electrode layer, the light emitting material layer and the second electrode layer are arranged in sequence along a direction in which the metal layer is away from the base substrate;
the first electrode of the light emitting element is formed in the second electrode layer, and the second electrode of the light emitting element is formed in the first electrode layer; a part of the first voltage line is formed in the first electrode layer.

25. (canceled)
